(19) United States
(12) Patent Application Publication
(10) Pub. No.: US 2023/0273537 A1
(43) Pub. Date: Aug. 31, 2023

(54) RESIN PARTICLES, TONER, DEVELOPER, TONER HOUSING UNIT, IMAGE FORMING APPARATUS, AND METHOD OF FORMING IMAGE

(71) Applicants: Yuka MIZOGUCHI, Shizuoka (JP); Junichi WATANABE, Shizuoka (JP); Kazuoki FUWA, Shizuoka (JP); Toshihiko SUGIYAMA, Shizuoka (JP); Natsuko MATSUSHITA, Shizuoka (JP)

(72) Inventors: Yuka MIZOGUCHI, Shizuoka (JP); Junichi WATANABE, Shizuoka (JP); Kazuoki FUWA, Shizuoka (JP); Toshihiko SUGIYAMA, Shizuoka (JP); Natsuko MATSUSHITA, Shizuoka (JP)

(21) Appl. No.: 18/109,285

(22) Filed: Feb. 14, 2023

(30) Foreign Application Priority Data
Feb. 28, 2022 (JP) 2022-030048
Nov. 4, 2022 (JP) 2022-177146

(51) Int. Cl. G03G 9/087; G03G 15/08

(52) U.S. Cl. CPC G03G 9/08755; G03G 15/0865

(57) ABSTRACT

[Summary] The invention is to provide resin particles capable of forming images with reduced environmental load, excellent low-temperature fixability, and chargeability characteristics, and excellent image quality can be obtained even when plant-derived resins are used.

[Tasks] Resin particles includes polyethylene terephthalate or polybutylene terephthalate, wherein a concentration of radioactive carbon isotope ¹⁴C in the resin particles is 10.8 pMC or more, and wherein the resin particles contain 0.05% by mass or more and 1% by mass or less of a divalent metal element excluding an external additive.

### CROSS-REFERENCE TO RELATED APPLICATION

The present application claims priority under 35 U.S.C. § 119 to Japanese Patent Application No. 2022-030048, filed Feb. 28, 2022 and No. 2022-177146, filed Nov. 4, 2022, the contents of which are incorporated herein by reference in their entirety.

### BACKGROUND OF THE INVENTION

### 1. Field of the Invention

The disclosures herein relate to resin particles, a toner, a developer, a toner housing unit, an image forming apparatus, and a method of forming images.

### 2. Description of the Related Art

Resin particles are widely used as toner of image forming apparatuses such as multi-functional printers (MFP) and printers in various places such as offices. In order to reduce the impact on the environment, the following are being considered for toner: reducing power consumption by improving the low-temperature fixability of the toner itself, reducing energy consumption during manufacturing, using biomass-derived resins for binder resins, and using recycled raw materials for binder resins. In particular, there is a growing demand for the use of recycled raw materials in binder resins because of the importance placed on the need to conserve resources, conserve energy, recycle resources, and the like.

Toner particles containing a binder resin manufactured using recycled raw materials include, for example, an amorphous polyester toner resin containing depolymerized PET polyol, an amorphous resin containing depolymerized recycled PET polyol and bio-based polyester or polyacid, and a crystalline resin containing depolymerized recycled PET polyol (see Japanese Patent No. 6138021).

### SUMMARY OF THE INVENTION

### Problems to be Solved by Invention

However, in the case of toner particles in Japanese Patent No. 6138021, there was a problem that, since the difference in composition between bio-based polyester or polyacid and non-bio-based polyester or polyacid is large, the agglomeration state of the toner tends to be different and the particle size distribution tends to deteriorate when the toner is produced.

One aspect of the present invention is to provide resin particles capable of forming images with reduced environmental load, excellent low-temperature fixability, and chargeability characteristics, and excellent image quality can be obtained even when plant-derived resins are used.

### Means to Solve Problems

One aspect of the resin particles according to the present invention includes resin particles containing polyethylene terephthalate or polybutylene terephthalate, wherein a concentration of radioactive carbon isotope ¹⁴C in the resin particles is 10.8 pMC or more, and wherein the resin particles contain 0.05% by mass or more and 1% by mass or less of a divalent metal element excluding an external additive.

### Effect of Invention

One aspect of the present invention is to provide resin particles capable of manufacturing a toner that forms images with reduced environmental load, excellent low-temperature fixability, and chargeability characteristics, and excellent image quality can be obtained even when plant-derived resins are used.

### BRIEF DESCRIPTION OF THE DRAWINGS

FIG. 1 is a schematic diagram illustrating an example of an image forming apparatus according to an embodiment;

FIG. 2 is a schematic diagram illustrating another example of an image forming apparatus according to an embodiment;

FIG. 3 is a schematic diagram illustrating an example of an image forming apparatus according to an embodiment;

FIG. 4 is a partially enlarged view of the image forming apparatus of FIG. 3; and

FIG. 5 is a schematic diagram illustrating an example of a process cartridge according to an embodiment.

### DESCRIPTION OF THE PREFERRED EMBODIMENTS

Embodiments of the present invention will be described in detail below. Embodiments are not limited by the following descriptions, and may be appropriately changed to the extent that the changes do not deviate from the gist of the invention. In addition, “to” denoting a numerical range in the specification means, unless otherwise stated, that the numerical values listed before and after the number are included as lower and upper limits.

<Resin Particles>

The resin particles according to one embodiment will be described. The resin particles according to one embodiment contain polyethylene terephthalate (PET) or polybutylene terephthalate (PBT). In addition to PET or PBT, the resin particles according to one embodiment preferably contain at least one of an amorphous resin and a crystalline resin, and may contain other components such as external additives and the like as needed.

(Concentration of Radioactive Carbon Isotope ¹⁴C)

A concentration of radioactive carbon isotope ¹⁴C (hereinafter sometimes referred to as “¹⁴C concentration”) of the resin particles according to one embodiment is 10.8 pMC or more, preferably 11 pMC or more, more preferably 20 pMC or more, and even more preferably 30 pMC or more. When the concentration of the radioactive carbon isotope ¹⁴C in the resin particles is less than 10.8 pMC, a biomass degree which will be described later tends to be recognized as a low biomass degree, and a reduction of impact on the environment cannot be realized.

The ¹⁴C is present in the natural world (in the atmosphere), and is taken up by photosynthesis during plant activity. The ¹⁴C concentration in the atmosphere and the ¹⁴C concentration taken up by plants are in equilibrium (107.5 pMC). However, the ¹⁴C taken by photosynthesis stops from the stage when organisms cease their life activity, and the ¹⁴C concentration halves every 5,730 years, which is the half-life of ¹⁴C. Since fossil resources from living sources are tens of thousands to hundreds of millions of years from the cessation of life, ¹⁴C concentration is rarely detected.

Here, “pMC” stands for percent Modern Carbon and defines the ratio of ¹⁴C to ¹²C in biomass in 1950 (¹⁴C/¹²C) as 100 pMC. However, the ¹⁴C concentration in the current atmosphere is increasing year by year. Therefore, it is prescribed to multiply the value by a factor for correction. An appropriate correction factor for the year is used for the correction.

The ¹⁴C concentration can also be represented as the degree of biomass calculated by the following formula (1).

Degree of Biomass (%)=¹⁴C concentration (pMC)/107.5×100 (1)

A ¹⁴C concentration of 10.8 pMC or higher means that the degree of biomass is 10% or higher. The degree of biomass of 10% or higher is also a desirable level from the standpoint of carbon neutrality.

A method of measuring the ¹⁴C concentration is not particularly limited and can be appropriately selected according to the purpose, but radiocarbon dating is particularly preferred.

The procedure for radiocarbon dating is to burn resin particles and reduce their carbon dioxide (CO₂) to obtain graphite (C). The ¹⁴C concentration in graphite is measured using an Accelerator Mass Spectroscopy (AMS), manufactured by Beta Analytic). This AMS measurement is disclosed, for example, in Japanese Patent No. 4050051 and the like.

(Content of Divalent Metal Elements)

The resin particles according to one embodiment contain 0.05% by mass to 1% by mass of divalent metal elements, excluding an external additive. The content of divalent metal elements is preferably 0.07% by mass to 0.80% by mass, more preferably 0.10% by mass to 0.70% by mass, and even more preferably 0.20%, by mass to 0.65% by mass.

Divalent metal elements are typical elements belonging to Group 2 of the periodic table and include beryllium (Be), magnesium (Mg), calcium (Ca), strontium (Sr), barium (Ba), and radium (Ra). Divalent metal elements are included in resin particles when inorganic fine particles and polymeric fine particles are used as external additives, when divalent metal salts are used as agglomerating agents, and when agglomerating agent and a terminating agent are used.

[Content of Divalent Metal Elements in Resin Particles]

The metal ions of the divalent metal elements contained in the resin particles according to one embodiment can be obtained by the methods and can be calculated by X-ray fluorescence or ICP-AES. For example, quantitative analysis of metal ions was carried out using a fluorescent X-ray device (ZSX Primus IV, manufactured by Rigaku Corporation). The shape of the resin particle sample to be measured is not particularly limited. If the sample is molded into pellet or sheet by a general pressure molding device, the sample is easy to handle. For example, a pellet tablet of resin particles about 2 mm in thickness was obtained by putting a sample into a tablet molding die with a diameter of 15 mm and pressurizing it for 1 minute under a load of 6 MPa. The obtained pellet tablets are placed in the sample holder of the X-ray fluorescence device, and the metal elements contained in the sample can be detected by performing quantitative analytical measurements. If an external additive is added to the resin particles, the amount of metal elements is measured after the external additive is removed from the resin particles. Any methods can be used to remove the external additive, such as adding 3.75 g of resin particles to 50 ml of 0.5% diluted surfactant (NOIGEN ET-165) and stirring with a ball mill. Ultrasonic energy (40 W, 5 minutes) is then applied with an ultrasonic homogenizer. After centrifuging the resin-dispersed solution applied with ultrasound, the solution is filtered to collect the precipitate. At this time, the above steps are repeated until the supernatant after centrifugation becomes clear. Then, the sample dried in a thermostatic bath is used to measure the amount of metal elements.

The resin particles in one embodiment can contain an external additive as another component as described below. If the external additive contains divalent metal elements, the content of the divalent metal elements contained in the resin particles will be the remaining divalent metal elements excluding the external additive. That is, the resin particles in one embodiment preferably contain 0.05% by mass to 1% by mass of the remaining divalent metal elements excluding the external additive.

Among the divalent metal elements, a content of Mg is preferably 0.1% by mass to 0.5% by mass, more preferably 0.15% by mass to 0.45% by mass, and even more preferably 0.2% by mass to 0.4% by mass.

When the resin particles contain Na, the divalent metal element contains more Mg than Na, and a content of Na preferably exceeds 0.05% by mass.

[PET or PBT]

PET or PBT contained in the resin particles of one embodiment is mainly contained in the resin particles to reduce the environmental load.

As PET or PBT, there are no particular limitations and PET or PBT can be appropriately selected according to the purpose. For example, recycled products, off-spec fiber waste, or pellets can be used. Recycled products (hereinafter sometimes referred to as “recycled resin”) that are processed into flakes are preferably used so as to reduce environmental load.

In this specification, biomass-derived resins and recycled resins are sometimes collectively referred to as “environmentally-friendly resins”.

The molecular weight distribution, composition, manufacturing method, and morphology of PET or PBT for use are not particularly limited, and these can be appropriately selected according to the purpose.

The weight-average molecular weight (Mw) of PET or PBT is not particularly limited and can be appropriately selected according to the purpose. The weight-average molecular weight is preferably in a range from 30,000 to 100,000.

Methods of analyzing and calculating the content of PET or PBT in the resin particles are not particularly limited, and general methods of calculating the amount of PET compounded can be used. As a method of analyzing and calculating the content of PET or PBT, for example, by performing separation from the resin particles by gel permeation chromatography (GPC) or the like, and using the analysis method described later for each separated component, the mass ratio of the components of the resin particles can be calculated.

PET or PBT in the resin particles can also be quantitatively analyzed by gas chromatography-mass spectrometry (GC/MS) at 300° C. with a reaction reagent (10% Tetramethyl ammonium hydroxide (TMAH)/methanol solution), estimating the main constituents from the soft degradation of ester bonds in the resin particles by methylation, and drawing a calibration curve of the total ion current chromatogram (TICC) intensity.

Separation of each component by GPC can be performed by, for example, the following methods.

In the GPC measurement using tetrahydrofuran (THF) as the mobile phase, the eluate is separated by a fraction collector and the like, and the fractions corresponding to the desired molecular weight part of the total integration of the elution curve are collected.

The collected eluate is concentrated and dried by an evaporator and the like, the solid content is then dissolved in a heavy solvent such as heavy chloroform, heavy THF, and the like. ¹H-NMR measurement is then performed to calculate the ratio of the constituent monomers of the resin in the eluted components from the integral ratio of each element.

Another method is to concentrate the eluate, hydrolyze the concentrated eluate with sodium hydroxide or the like, and perform qualitative and quantitative analysis of the degradation product by high-performance liquid chromatography (HPLC) or the like to calculate the constituent monomer ratio.

The content of PET or PBT is not particularly limited and can be appropriately selected according to the purpose. The content of PET or PBT is preferably in a range from 5 parts by mass to 70 parts by mass, and more preferably in a range from 10 parts by mass to 50 parts by mass with respect to 100 parts by mass of the resin particles. If the content of PET or PBT is 70 parts by mass or less with respect to 100 parts by mass of the resin particles, low-temperature fixability can be achieved. If the content of PET or PBT is 5 parts by mass or more with respect to 100 parts by mass of the resin particles, the effect of reducing environmental load can be exerted and the resin particles can have an excellent particle size distribution. If the content of PET or PBT is in the more favorable range mentioned above, it is advantageous in that both the reduction of the environmental load of the resin particles and the improvement of the particle size distribution are compatible.

An example of a means for separating each component contained in the resin particles when analyzing the resin particles according to an embodiment is described in detail. First, 1 g of the resin particles is put into 100 mL of THF, and a solution in which soluble contents are dissolved is obtained under the conditions of 25° C. and stirring for 30 minutes. The solution is filtered through a membrane filter with a 0.2 μm mesh opening to obtain the THF-soluble fraction in the resin particles. This is then dissolved in THF to make a sample for GPC measurement and injected into the GPC used to measure the molecular weight of each resin mentioned above. On the other hand, a fraction collector is placed at the effluent outlet of the GPC to separate the eluate at every predetermined count, and eluate is obtained at every 5% area ratio from the start of elution of the elution curve (the rise of the curve). Then, for each eluate, 30 mg of the sample is dissolved in 1 mL of heavy chloroform, and 0.05% by volume of tetramethylsilane (TMS) as the reference material is added to each eluate. The solution is packed in a 5 mm-diameter glass tube for NMR measurement, and the measurement is repeated for 128 times using a nuclear magnetic resonance apparatus (JNM-AL 400 made by Nippon Denshi Co., Ltd.) at a temperature of 23° C. to 25° C. to obtain spectrum. The monomer composition and composition ratio of PET resins or the like contained in the resin particles can be obtained from the peak integral ratio of the obtained spectrum.

[Biomass-Derived Resins]

The resin particles in one embodiment preferably contain a biomass-derived resin. The biomass-derived resin may be contained in at least one of the amorphous resin and crystalline resin described below.

Biomass-derived resins are resins that contain plant-derived compounds as raw materials. The biomass-derived resin may be contained in the crystalline resin described later, the amorphous resin, or other components such as mold release agents. By adjusting the ratio of petroleum-derived and plant-derived components of the alcohol and acid components that constitute the resin particles, an environmentally-friendly ratio and toner quality when the resin particles are applied to toner can be adjusted as described below.

In recent years, there has been a strong demand for improved toner function while improving environmental responsiveness, including biomass-derived resins. Many petroleum-based resins have aromatic ring skeletons in their constituent monomers. However, for biomass-derived resins, when a quality with low-temperature fixability is required, aliphatic monomers that do not have an aromatic ring skeleton are often used as their constituent monomers. This causes significant structural differences and poor particle size distribution during the production of resin particles.

In response to the above problems, the resin particles in one embodiment contain PET or PBT having an aromatic ring skeleton, which can reduce the structural differences of biomass-derived resins while enhancing environmental responsiveness. In addition, in the case where fine resin particles are agglomerated by using metal salts during the manufacture of resin particles, if the resin particles are agglomerated with use of trivalent or higher metal salts that have a large degree of crosslinking, resulting in a poor particle size distribution. Meanwhile, if the resin particles are gently agglomerated with use of divalent metal salts, resulting in a good particle size distribution.

Therefore, the resin particles in one embodiment can reduce the environmental load and have an excellent particle size distribution.

As described above, the resin particles in one embodiment preferably contain at least one of the amorphous resin and crystalline resin in addition to PET or PBT, and more preferably contain both the amorphous resin and crystalline resin.

The total content of the biomass-derived resin and PET or PBT with respect to the total mass of the resin particles is preferably 50% by mass or more, more preferably 60% by mass or more, and even more preferably 80% by mass or more.

The resin particles in one embodiment include PET or PBT and a biomass-derived resin, as described above. The content of PET or PBT is preferably more than that of biomass-derived resin in the resin particles.

[Amorphous Resin]

The resin particles in one embodiment preferably contain an amorphous resin.

Terpene resins and amorphous (amorphous-type) polyester resins (hereafter, it is also referred to as “amorphous polyester resin B”) are preferably used as the amorphous resins. Among the amorphous resins, linear polyester resins are preferably used, and unmodified polyester resins are preferably used. In addition, environmentally-friendly resins are preferably used. In the present embodiment, amorphous resin refers to the one excluding PET or PBT.

An unmodified polyester resin is a polyester resin obtained by using a polyvalent alcohol and a polyvalent carboxylic acid such as a polycarboxylic acid, a polycarboxylic anhydride, and a polycarboxylic ester or its derivative, and is a polyester resin which is not modified by an isocyanate compound or the like.

The amorphous polyester resin preferably has neither urethane bond nor urea bond.

The amorphous polyester resin contains a dicarboxylic acid component as a constituent, and the dicarboxylic acid component preferably contains 50% mol, or more of terephthalic acid. This has an advantage in terms of heat-resistant storage.

Examples of polyvalent alcohols include diols and the like.

Examples of diols include alkylene (2 to 3 carbon atoms) oxide (average additive mole number of 1 to 10) adducts of bisphenol A such as polyoxypropylene (2.2)-2,2-bis(4-hydroxyphenyl) propane, polyoxyethylene (2.2)-2,2-bis(4-hydroxyphenyl) propane, and the like; ethylene glycol, neopentyl glycol, and propylene glycol; hydrogenated bisphenol A, alkylene (2 to 3 carbon atoms) oxide (average additive molar number of 1 to 10) adducts of hydrogenated bisphenol A; and the like.

These may be used alone or in combination of two or more.

Among these, ethylene glycol or propylene glycol that is derived from plants is preferably used.

Examples of the polycarboxylic acid include dicarboxylic acid and the like.

Examples of dicarboxylic acids include adipic acid, phthalic acid, isophthalic acid, terephthalic acid, fumaric acid, and maleic acid; succinic acid substituted with an alkyl group with 1 to 20 carbon atoms such as dodecenylsuccinic acid, octylsuccinic acid, and the like or an alkenyl group with 2 to 20 carbon atoms, modified purified rosin, and the like. The modified purified rosin is preferably modified with acrylic acid, fumaric acid, and maleic acid.

Among these, plant-derived saturated aliphatic succinic acid, modified purified rosin, and the like are preferably used. Plant-derived acid or rosin can increase carbon neutrality. Saturated aliphatic resins have the effect of increasing the recrystallization properties of crystalline polyester resins, thus increasing the aspect ratio of crystalline polyester resins and improving low-temperature fixability.

These may be used alone or in combination of two or more.

In addition, for the purpose of adjusting the acid value and the hydroxyl value, the amorphous polyester resin may contain at least one of trivalent or higher carboxylic acid and trivalent or higher alcohol at the end of the resin chain.

Examples of the trivalent or higher carboxylic acids include trimellitic acid, pyromellitic acid, their anhydrides, or the like.

Examples of the trivalent or higher alcohols include glycerin, pentaerythritol, trimethylolpropane, or the like.

The molecular weight of the amorphous polyester resin is not particularly limited, and can be appropriately selected according to the purpose. In gel permeation chromatography (GPC) measurements, the weight-average molecular weight (Mw) is preferably in a range from 3,000 to 10,000. The number-average molecular weight (Mn) is preferably in a range from 1,000 to 4,000. The ratio of weight-average molecular weight (Mw) to number-average molecular weight (Mn), Mw/Mn, is preferably in a range from 1.0 to 4.0.

When the molecular weight is the lower limit value or more, the degradation of the heat-resistant storage of the resin particles and the durability against stress such as stirring in the developer can be suppressed. When the molecular weight is the upper limit value or less, the increase in viscoelasticity of the resin particles during melting can be suppressed and the decrease in low-temperature fixability can be suppressed.

The weight-average molecular weight (Mw) is more preferably in a range from 4,000 to 7,000. The number-average molecular weight (Mn) is more preferably in a range from 1,500 to 3,000. The ratio of weight-average molecular weight (Mw) to number-average molecular weight (Mn), Mw/Mn, is more preferably in a range from 1.0 to 3.5.

The acid value of the amorphous polyester resin is not particularly limited, and can be appropriately selected according to the purpose. The acid value of the amorphous polyester resin is preferably in a range from 1 mg KOH/g to 50 mg KOH/g, and more preferably in a range from 5 mg KOH/g to 30 mg KOH/g. When the acid value is 1 mg KOH/g or more, the resin particles tend to become negatively charged, and furthermore, the affinity between paper and the resin particles at the time of fixing to the paper improves the low-temperature fixability. When the acid value is 50 mg KOH/g or less, the decrease in the chargeability stability, especially the decrease in the chargeability stability against environmental fluctuations, can be suppressed.

The hydroxyl value of the amorphous polyester resin is not particularly limited and can be appropriately selected according to the purpose. The hydroxyl value of the amorphous polyester resin is preferably 5 mg KOH/g or more.

The glass transition temperature (Tg) of the amorphous polyester resin is preferably in a range from 40° C. to 80° C., and more preferably in a range from 50° C. to 70° C. When the glass transition temperature (Tg) is 40° C. or higher, the heat-resistant storage of resin particles and the durability against stress such as agitation in the developer become sufficient, and the filming resistance also become favorable. When the glass transition temperature (Tg) is 80° C. or less, the resin particles are sufficiently deformed by heating and pressurization during the fixing step, and the low-temperature fixability becomes favorable.

The molecular structure of amorphous polyester resins can be confirmed by NMR measurement in solution or in solid state, as well as X-ray diffraction, GC/MS, LC/MS, IR measurement, and the like. A simple method is to detect, as an amorphous polyester resin, those having no absorption at 965±10 cm⁻¹ and 990±10 cm⁻¹ based on the δ_{CH} (out-of-plane bending vibration) of olefins in the infrared absorption spectrum.

The content of the amorphous polyester resin is not particularly limited, and can be appropriately selected according to the purpose. The content is preferably in a range from 50 parts by mass to 90 parts by mass, and more preferably in a range from 60 parts by mass to 80 parts by mass, with respect to 100 parts by mass of the resin particles. When the content is 50 parts by mass or more, deterioration in dispersibility of a pigment and a release agent in the resin particles can be suppressed, and occurrence of image blurring and distortion can be suppressed. When the content is 90 parts by mass or less, the content of crystalline polyester resin C and amorphous polyester resin B is prevented from decreasing, and the decrease in low-temperature fixability can be suppressed. When the content is in the above more-preferable range, it is advantageous in that both high image quality and low temperature fixability are excellent.

[Amorphous Resin (Prepolymer)]

The resin particles in one embodiment may contain an amorphous resin (prepolymer) to improve low-temperature fixability.

Reactive precursors include polyesters having reactive groups that can react with active hydrogen groups.

Examples of groups that can react with active hydrogen groups include isocyanate groups, epoxy groups, carboxylic acids, acid chloride groups, and the like. Among these, isocyanate groups are preferably used in that urethane or urea bonds can be introduced into the amorphous polyester resin.

The reactive precursor may have branched structures imparted by at least one of trivalent or higher alcohols and trivalent or higher carboxylic acids.

Examples of the polyester resin containing an isocyanate group include a reaction product of a polyester resin having an active hydrogen group and a polyisocyanate.

A polyester resin having an active hydrogen group is obtained, for example, by polycondensation of a diol, a dicarboxylic acid, and at least one of the trivalent or higher alcohols and trivalent or higher carboxylic acids. The trivalent or higher alcohols and trivalent or higher carboxylic acids impart branched structures to polyester resins containing isocyanate groups.

Examples of diols include aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, 1,12-dodecanediol, and the like; diols with oxyalkylene groups such as diethylene glycol, triethylene glycol, dipropylene glycol, polyethylene glycol, polypropylene glycol, polytetramethylene glycol, and the like; alicyclic diols such as 1,4-cyclohexanedimethanol, hydrogenated bisphenol A, and the like; alkylene oxides such as ethylene oxide, propylene oxide, butylene oxide added to alicyclic diols; bisphenols such as bisphenol A, bisphenol F, bisphenol S, and the like; and alkylene oxide adducts of bisphenols, such as bisphenols to which alkylene oxides such as ethylene oxide, propylene oxide, and butylene oxide are added. Among these, from the viewpoint of controlling the glass transition temperature (Tg) of amorphous polyester resin A to 20° C. or less, aliphatic diols having 3 to 10 carbon atoms, such as 1,2-propylene glycol, 1,3-propylene glycol, 1,4-butanediol, 2-methyl-1,3-propanediol, 1,5-pentanediol, 3-methyl-1,5-pentanediol, and the like are preferably used, and 50 mol or more of the alcohol component in the resin is more preferably used. These diols may be used alone or in combination of two or more.

Amorphous polyester resin A has steric hindrance in the resin chain, which reduces the melt viscosity at the time of fixing and makes it easier to realize low-temperature fixability. For this reason, the main chain of the aliphatic diol preferably has a structure represented by general formula (1) below.

HO—(CR¹R²)ₙ—OH (1)

However, in general formula (1), R¹ and R² each independently represent a hydrogen atom and an alkyl group having 1 to 3 carbon atoms. n represents an odd number of 3 to 9. In n repeating units, R¹ and R² may be identical to each other or may be different from each other.

Here, the main chain of an aliphatic diol is a carbon chain connected by the shortest number of carbon atoms between the two hydroxyl groups of the aliphatic diol. If the number of carbon atoms in the main chain is odd, it is preferable because the crystallinity decreases due to Odd-Even effects. It is also more preferable when the side chain contains at least 1 or more alkyl groups with a carbon number of 1 to 3 because the interaction energy between the main chain molecules decreases due to the stericity.

Examples of dicarboxylic acids include aliphatic dicarboxylic acids such as succinic acid, adipic acid, sebacic acid, dodecanedioic acid, maleic acid, fumaric acid, and the like; aromatic dicarboxylic acids such as phthalic acid, isophthalic acid, terephthalic acid, naphthalenedicarboxylic acid, and the like. These anhydrides, lower (1 to 3 carbon atoms) alkyl esters and halides may also be used. Among these, from the viewpoint of controlling the glass transition temperature (Tg) of amorphous polyester resin A to 20° C. or less, aliphatic dicarboxylic acids with 4 to 12 carbon atoms are preferably used, and more preferably 50% by mass or more of the carboxylic acid component in the resin is more preferably used. These dicarboxylic acids may be used alone or in combination of two or more.

Examples of trivalent or higher alcohols include trivalent or higher aliphatic alcohols such as glycerin, trimethylolethane, trimethylolpropane, pentaerythritol, sorbitol, and the like; trivalent or higher polyphenols such as trisphenol PA, phenol novolac, cresol novolac, and the like; alkylene oxide adducts of trivalent or more polyphenols, such as polyphenols with alkylene oxides such as ethylene oxide, propylene oxide, butylene oxide, and the like; and the like.

The trivalent or higher carboxylic acids include, for example, trivalent or higher aromatic carboxylic acids. Especially, trivalent or higher aromatic carboxylic acids with 9 to 20 carbon atoms such as trimellitic acid, pyromellitic acid, and the like are preferably used. Furthermore, these anhydrates, lower (1 to 3 carbon atoms) alkyl esters, and halides may also be used.

Examples of polyisocyanates include diisocyanates, trivalent or higher isocyanates, and the like.

Polyisocyanates are not particularly limited and can be appropriately selected for the intended purpose. Examples of polyisocyanates include aromatic diisocyanates such as 1,3- and/or 1,4-phenylenediisocyanate, 2,4- and/or 2,6-tolylene diisocyanate (TDI), crude TDI, 2,4′- and/or 4,4′-diphenylmethane diisocyanate (MDI), crude MDI [a phosgene product of crude diaminophenylmethane (condensation product of formaldehyde with aromatic amines (aniline) or mixtures thereof; a mixture of diaminodiphenylmethane and a small amount (e.g., 5 to 20% by mass) of tri-functional or higher polyamine): polyaryl polyisocyanates (PAPI)], 1,5-naphthylene diisocyanate, 4,4′,4″-triphenylmethane triisocyanate, m- and p-isocyanatophenylsulfonyl isocyanates, and the like; aliphatic diisocyantes such as ethylene diisocyanate, tetramethylene diisocyanate, hexamethylene diisocyanate (HDI), dodecamethylene diisocyanate, 1,6,11-undecane triisocyanate, 2,2,4-trimethyl hexamethylene diisocyanate, lysine diisocyanate, 2,6-diisocyanatomethyl caproate, bis(2-isocyanatoethyl) fumarate, bis(2-isocyanatoethyl) carbonate, 2-isocyanatoethyl-2,6-diisocyanatohexanoate, and the like; alicyclic diisocyanates such as isophorone diisocyanate (IPDI), dicyclohexylmethane-4,4′-diisocyanate (hydrogenated MDI), cyclohexyl diisocyanate, methylcyclohexyl diisocyanate (hydrogenated TDI), bis(2-isocyanatoethyl)-4-cyclohexene-1,2-dicarboxylate, 2,5- and 2,6-norbornane diisocyanates; aromatic aliphatic diisocyanates such as m- and p-xylylene diisocyanates (XDI), α,α′,α′,α′-tetramethylxylylene diisocyanates (TMXDI), and the like; trivalent or higher polyisocyanates such as lysine triisocyanate, trivalent or higher alcohols of diisocyanate denaturation, and the like; and modified product of these isocyanates. Alternatively, a mixture of two or more of these can be used. Examples of the modified products of the isocyanate include modified products containing a urethane group, carbodiimide group, allophanate group, urea group, burette group, urethodione group, ureteimine group, isocyanurate group, and oxazolidone group.

[Crystalline Resin]

A crystalline resin is preferably added to the resin particles of one embodiment to improve low-temperature fixability.

As for the crystalline resin, there is no particular limitations as long as the crystalline resin has crystallinity, and the crystalline resin can be selected appropriately according to the purpose. Examples of the crystalline resins include polyester resins, polyurethane resins, polyurea resins, polyamide resins, polyether resins, vinyl resins, modified crystalline resins, and the like. These may be used alone or in combination of two or more.

The polyester resin used in the crystalline resin is crystalline polyester resin (hereafter, the polyester resin is sometimes referred to as “crystalline polyester resin C”). The crystalline polyester resin C is described below.

The crystalline polyester resin C has high crystallinity. Therefore, the crystalline polyester C exhibits a thermal melting property that shows a rapid viscosity change near the fixing onset temperature.

By using crystalline polyester resin C having these properties together with amorphous polyester resin B, resin particles with excellent heat-resistant storage and low-temperature fixability can be obtained. For example, when they are used together, heat-resistant storage is excellent due to its crystallinity until the melting onset temperature, and a rapid viscosity decrease (sharp melt property) due to the melting of the crystalline polyester resin C is caused at the melting onset temperature. Accordingly, the crystalline polyester resin C is compatible with the aforementioned amorphous polyester resin B, and both rapidly decrease in viscosity, so that the resin particles can be favorably fixed.

(Crystalline Polyester Resin)

The crystalline polyester resin is obtained through reaction between polyvalent alcohol and a polyvalent carboxylic acid (e.g., polyvalent carboxylic acid itself, polyvalent carboxylic anhydride, and polyvalent carboxylic acid ester).

In the present embodiment, the crystalline polyester resin is defined as one obtained by using a polyvalent alcohol and a polyvalent carboxylic acid such as a polycarboxylic acid, a polycarboxylic anhydride, a polycarboxylic ester, or a derivative thereof, as described above. Modified polyester resins, for example, prepolymers, and resins obtained by cross-linking and/or elongation reaction of such prepolymers, do not belong to the aforementioned crystalline polyester resins.

((Polyvalent Alcohol))

Polyvalent alcohols are not particularly limited and can be appropriately selected according to the purpose. For example, diols and trivalent or higher alcohols can be used.

Examples of the diol include saturated aliphatic diols. The saturated aliphatic diols include linear saturated aliphatic diols and branched saturated aliphatic diols. Among them, linear saturated aliphatic diols are preferably used, and linear saturated aliphatic diols with 2 to 12 carbon atoms are more preferably used. If the saturated aliphatic diol is a branched type, the crystallinity of the crystalline polyester resin may be decreased and the melting point of the crystalline polyester resin may be lowered. If the carbon atoms of the saturated aliphatic diol exceeds 12, it becomes difficult to obtain the material for practical use.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosandecanediol, and the like. Among these, ethylene glycol, 1,4-butanediol, 1,6-hexanediol, 1,8-octanediol, 1,9-nonanediol, 1,10-decanediol, and 1,12-dodecanediol are preferably used because the crystalline polyester resin has high crystallinity and excellent sharp-melt properties.

Examples of trivalent or higher alcohols include glycerin, trimethylolethane, trimethylolpropane, pentaerythritol, and the like. These may be used alone or in combination of two or more.

((Polyvalent Carboxylic Acid))

Polyvalent carboxylic acids are not particularly limited and can be appropriately selected according to the purpose. For example, divalent carboxylic acids and trivalent or higher carboxylic acids can be used.

Examples of divalent carboxylic acids include saturated aliphatic dicarboxylic acids such as oxalic acid, succinic acid, glutaric acid, adipic acid, speric acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like; aromatic dicarboxylic acids such as phthalic acid, isophthalic acid, terephthalic acid, naphthalene-2,6-dicarboxylic acid, malonic acid, mesaconic acid, and the like; and the like. In addition, these anhydrides and these lower (1 to 3 carbon atoms) alkyl esters are also used. Among them, saturated aliphatic groups with 12 or less carbon atoms of plant-derived saturated aliphatic groups are preferably used from a carbon-neutral standpoint.

Examples of trivalent or higher carboxylic acids include 1,2,4-benzenetricarboxylic acid, 1,2,5-benzenetricarboxylic acid, 1,2,4-naphthalenetricarboxylic acid, and their anhydrides and their lower (1 to 3 carbon atoms) alkyl esters.

These may be used alone or in combination of two or more.

The crystalline polyester resin is preferably composed of a linear saturated aliphatic dicarboxylic acid with 4 to 12 carbon atoms and a linear saturated aliphatic diol with 2 to 12 carbon atoms. Such structure enables an excellent low-temperature fixability to be exerted because of the high crystallinity and excellent sharp-melt properties. In addition, methods for controlling the crystallinity and softening point of crystalline polyester resins include designing and using non-linear polyesters or the like that undergo condensation polymerization by adding trivalent or higher polyvalent alcohol such as glycerin to the alcohol component or trivalent or higher polycarboxylic acid such as trimellitic anhydride to the acid component during polyester synthesis.

The molecular structure of crystalline polyester resins can be confirmed by NMR measurements in solutions and solids, as well as X-ray diffraction, GC/MS, LC/MS, IR measurements, and the like. However, in the infrared absorption spectra, examples can be taken that have absorption based on the δ_{CH} (out-of-plane bending vibration) of olefins at 965±10 cm⁻¹ or 990±10 cm⁻¹.

In terms of molecular weight, those with a sharp molecular weight distribution and a low molecular weight are excellent in low-temperature fixability, while many components with a low molecular weight deteriorate heat-resistant storage. From this point of view, it is preferable that the molecular weight distribution by GPC of the soluble part of o-dichlorobenzene has a peak position in the range of 3.5 to 4.0 on the molecular weight distribution map with log (M) on the horizontal axis and % by mass on the vertical axis, a peak width at half maximum of 1.5 or less, a weight-average molecular weight (Mw) of 3,000 to 30,000, a number-average molecular weight (Mn) of 1,000 to 10,000, and a weight-average molecular weight (Mw) to number-average molecular weight (Mn) ratio Mw/Mn of 1 to 10. Furthermore, it is more preferable that the weight-average molecular weight (Mw) is 5,000 to 15,000, the number-average molecular weight (Mn) is 2,000 to 10,000, and the ratio of Mw/Mn is 1 to 5.

The acid value of the crystalline polyester resin is preferably 5 mg KOH/g or more in order to achieve the desired low-temperature fixability in terms of the affinity between paper and resin. For the preparation of fine particles by the phase transfer emulsification method, the acid value of the crystalline polyester resin is more preferably 7 mg KOH/g or more. On the other hand, in order to improve the hot offsetting property, the acid value of the crystalline polyester resin is preferably 45 mg KOH/g or less.

In addition, the hydroxyl value of the crystalline polyester resin is preferably 0 to 50 mg KOH/g and more preferably 5 to 50 mg KOH/g in order to achieve the predetermined low-temperature fixability and to achieve excellent chargeability characteristics.

[Other Components]

The resin particles of one embodiment may contain other components. Examples of other components include wax, external additives, colorants, charge controlling agents, cleanability improver, magnetic materials, and the like.

(Wax)

The wax is not particularly limited and can be selected appropriately according to the purpose, but a release agent with a low melting point of 50 to 120° C. is preferably used. When the wax having low temperature melting point is dispersed with the resin, the wax as a release agent effectively acts between fixing rollers and the interfaces of the resin particles, thereby providing excellent hot offset even without oil (no release agent like oil is applied to the fixing roller).

The release agents preferably include, for example, waxes or the like. The waxes include, for example, natural waxes including botanical waxes such as carnauba wax, cotton wax, japan wax, and rice wax; animal waxes such as beeswax, and lanolin; mineral-based waxes such as ozocerite, and ceresin; and petroleum waxes such as paraffin, microcrystalline, and petrolatum; and the like. The waxes include, for example, natural waxes including botanical waxes such as carnauba wax, cotton wax, japan wax, and rice wax; animal waxes such as beeswax, and lanolin; mineral-based waxes such as ozocerite, and ceresin; and petroleum waxes such as paraffin, microcrystalline, and petrolatum; and the like. Furthermore, aliphatic acid amides such as 12-hydroxystearic acid amide, amide stearate, phthalimide anhydride, or chlorinated hydrocarbons; homopolymers or copolymers of polyacrylate such as poly-n-stearyl methacrylate, or poly-n-lauryl methacrylate, which is a crystalline high polymer resin with a low molecular weight (e.g. a copolymer of n-stearyl acrylate-ethyl methacrylate); a crystalline polymer having a long alkyl group in the side chain; and the like may be used. The above-described polymers may be used singly, or a combination of two or more polymers may be used.

From the viewpoint of reducing environmental load, plant-based wax is preferably used.

The melting point of the wax is not particularly limited, and can be appropriately selected according to the purpose. The melting point preferably is within a range from 50° C. to 120° C., and more preferably is within a range from 60° C. to 90° C. When the melting point is 50° C. or higher, it is possible to suppress bad influence brought from the wax to the heat-resistant storage. When the melting point is 120° C. or lower, it is possible to effectively suppress an occurrence of a cold offset at the time of fixing at low temperature. A melt viscosity of the wax, as a measured value at a temperature higher than the melting point of the wax by 20° C., preferably is within a range from 5 cps to 1,000 cps, and more preferably is within a range from 10 cps to 100 cps. When the melt viscosity is 5 cps or more, it is possible to retain acceptable releasability. When the melt viscosity is 1,000 cps or less, effects of hot offset resistance and the low temperature fixing property can be exhibited sufficiently. The content of the wax in the resin particles is not particularly limited, and can be appropriately selected according to the purpose. The content preferably is within a range from 0% by mass to 40% by mass, and more preferably is within a range from 3% by mass to 30% by mass.

(External Additive)

Inorganic fine particles and polymeric fine particles can be used as the external additive.

Examples of the inorganic fine particles include silica, alumina, titanium oxide, barium titanate, magnesium titanate, calcium titanate, strontium titanate, iron oxide, copper oxide, zinc oxide, tin oxide, silica sand, clay, mica, silica stone, diatomaceous earth, chromium oxide, cerium oxide, bengara, antimony trioxide, magnesium oxide, zirconium oxide, barium sulfate, barium carbonate, calcium carbonate, silicon carbide, silicon nitride, and the like. Among these, silica, alumina, and titanium oxide are preferably used.

In addition, the inorganic fine particles may be surface-treated with a hydrophobizing agent to enhance their hydrophobicity and suppress deterioration of their flow and chargeability characteristics even under high humidity. Examples of the hydrophobizing agents include silane coupling agents, silylating agents, silane coupling agents with alkyl fluoride groups, organic titanate-based coupling agents, aluminum-based coupling agents, silicone oils, modified silicone oils, and the like.

Examples of the polymeric fine particles include polystyrene obtained by soap-free emulsion polymerization, suspension polymerization, and dispersion polymerization, polycondensation systems such as methacrylate and acrylic ester copolymers, silicon, benzoguanamine and nylon, and polymer particles made of thermosetting resins.

The average particle size of the primary particles of the inorganic fine particles is not particularly limited and can be appropriately selected according to the purpose, but is preferably 5 nm to 2 μm, more preferably 10 nm to 500 nm. If the average particle size is 5 nm or more, the agglomeration of the inorganic fine particles is suppressed and the inorganic fine particles can be uniformly dispersed in the resin particles. If the average particle size is 2 μm or less, the filler effect improves the heat-resistant storage.

Note that the average particle size is the value obtained directly from the photograph obtained by transmission electron microscopy, and it is preferable to observe at least 100 or more particles and use the average of their major diameters.

The specific surface area of the inorganic fine particles by the BET method is preferably 20 to 500 m²/g.

The content of the inorganic fine particles is preferably 0.01s by mass to 5% by mass of the resin particles.

(Colorant) Known dyes and pigments can be used as coloring agents. Examples of the colorants may include, for example, carbon black, nigrosine dye, iron black, naphthol yellow S, hansa yellow (10G, 5G, G), cadmium yellow, yellow iron oxide, loess, chrome yellow, titan yellow, polyazo yellow oil yellow, hansa yellow (GR, A, RN, R), pigment yellow L, benzidine yellow (G, GR), permanent yellow (NCG), vulcan fast yellow (5G, R), tartrazine lake, quinoline yellow lake, anthracite yellow BGL, isoindolinone yellow, colcothar, red lead, vermilion, cadmium red, cadmium mercury red, antimony vermilion, permanent red 4R, paranitraniline red, fire red, para chloro ortho nitro aniline red, lithol fast scarlet G, brilliant fast scarlet, brilliant carmine BS, permanent red (F2R, F4R, FRL, FRLL, F4RH), fast scarlet VD, vulcan fast rubine B, brilliant scarlet G, lithol rubine GX, permanent red F5R, brilliant carmine 6B, pigment scarlet 3B, bordeaux 5B, toluidine maroon, permanent bordeaux F2K, helio bordeaux BL, bordeaux 10B, bon maroon light, bon maroon medium, eosine lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkaline blue lake, peacock blue lake, victoria blue lake, metal-free phthalocyanine blue, phthalocyanine blue, fast sky blue, indanthrene blue (RS, BC), indigo, ultramarine blue, prussian blue, anthraquinone blue, fast violet B, methyl-violet lake, cobalt violet, manganese violet, dioxane violet, anthraquinone violet, chrome green, zinc green, chrome oxide, viridian, emerald green, pigment green B, naphthol green B, green gold, acid green lake, malachite green lake, phthalocyanine green, anthraquinone green, titanium oxide, zinc white, lithopone, and a mixture thereof.

(Charge Controlling Agent)

General charge controlling agents can be used as an charge controlling agent in the present embodiment. Examples of the charge controlling agents include nigrosine-based dyes, triphenylmethane-based dyes, chromium-containing metal complex dyes, molybdate chelate pigments, rhodamine-based dyes, alkoxy amines, quaternary ammonium salts (including fluorine-modified quaternary ammonium salts), alkylamides, single or compound of phosphorus, single or compound of tungsten, fluorine-based activators, metal salicylate salts, metal salts of salicylic acid derivatives, and the like. Specific examples of the charge controlling agents include Bontron 03 for nigrosine dyes, Bontron P-51 for quaternary ammonium salts, Bontron S-34 for metal-containing azo dyes, E-82 for oxynaphthoic acid metal complexes, E-84 for salicylic acid metal complexes, E-89 for phenolic condensates (manufactured by Orient Chemical Industries, Inc.), TP-302 and TP-415 for quaternary ammonium salt molybdenum complexes (manufactured by Hodogaya Chemical Co., Ltd.), copy charge PSY VP 2038 for quaternary ammonium salts, copy blue PR for triphenylmethane derivatives, copy charge NEG VP 2036 for quaternary ammonium salts, copy charge NX VP 434 (manufactured by Hoechst.), LRA-901, boron complex LR-147 (manufactured by Carlitt Japan), copper phthalocyanine, perylene, quinacridone, azo pigments, and other polymeric compounds with functional groups such as sulfonic acid groups, carboxyl groups, and quaternary ammonium salts. The charge controlling agents may be used in an amount in the range of performance that does not disturb the fixability and the like. The charge controlling agent is contained in an amount of 0.5% by mass to 5% by mass and more preferably in an amount of 0.8% by mass to 3% by mass in the resin particles.

(Cleanability Improver)

The cleanability improvers are not particularly limited as long as the cleanability improvers are added to the resin particles to remove any post-transfer developer that remains on a photoconductor and a primary transfer medium, and can be appropriately selected according to the purpose. Examples of the cleanability improvers include fatty acid metal salts such as zinc stearate, calcium stearate, stearic acid, and the like; polymer fine particles produced by soap-free emulsion polymerization such as polymethyl methacrylate fine particles, polystyrene fine particles, and the like. The polymer fine particles preferably have a relatively narrow particle size distribution, and those with a volume average particle size of 0.01 to 1 μm are preferably used.

(Magnetic Material)

The magnetic material is not particularly limited and can be appropriately selected from the known materials according to the purpose. Examples of the magnetic materials include iron powder, magnetite, ferrite, and the like. Among these, white ones are preferable in terms of color tone.

<Characteristics of Resin Particles>

[Particle Size of Resin Particles]

The particle size of the resin particles in one embodiment is measured by Coulter Multisizer III (manufactured by Coulter). Measurements of the particle size of resin particles are obtained as follows. First, 2 mL of a surfactant (Sodium dodecylbenzenesulfonate, manufactured by Tokyo Kasei) as a dispersing agent is added to 100 mL of an electrolytic solution. The electrolytic solution is prepared in about 1% NaCl aqueous solution using primary sodium chloride, and ISOTON-II (manufactured by Coulter) can be used. To the mixture of electrolytic solution and surfactant, 10 mg of solid sample is added to obtain an electrolytic solution in which the sample is suspended. The electrolytic solution in which the sample is suspended is dispersed in an ultrasonic disperser for about 1 to 3 minutes, and the volume and number of resin particles are measured by Coulter Multisizer III using a 100 μm aperture as the aperture to calculate the volume distribution and number distribution. From the obtained distribution, the volume-average particle size (Dv) of the resin particles is obtained.

[Method of Measuring Melting Point and Glass Transition Temperature (Tg)]

A melting point and a glass transition temperature Tg can be measured using, for example, a differential scanning calorimeter (DSC) system (Q-200, by TA Instruments, Inc.). Specifically, the melting point and the glass transition temperature of the sample can be measured according to the following steps. The sample of about 5.0 mg is put in a sample container made of aluminum, the sample container is placed on a holder unit, and set in an electric furnace. Then, the sample is heated from −80° C. to 150° C. under a nitrogen atmosphere at a rate of 10° C./min (first temperature increase). Then, the sample is cooled from 150° C. to −80° C. at a temperature falling rate of 10° C./min, and heated again to 150° C. at a rate of 10° C./min (second temperature increase). In each of the first and second temperature increases, a DSC curve is measured using a differential scanning calorimeter (DSC) system (Q-200, by TA Instruments, Inc.). The DSC curve for the first temperature increase is selected, and the glass transition temperature (Tg) in the first temperature increase for the sample is obtained from the DSC curves using an analysis program in the Q-200 system. Similarly, the DSC curve for the second temperature increase is selected, and the glass transition temperature (Tg) in the second temperature increase for the sample is obtained from the DSC curve.

The DSC curve for the first temperature increase is selected, and a heat absorbing peak top temperature in the first temperature increase for the sample is obtained as the melting point from the DSC curve using the analysis program in the Q-200 system. Similarly, the DSC curve for the second temperature increase is selected, and a heat absorbing peak top temperature in the second temperature increase for the sample is obtained as the melting point from the DSC curve.

In this specification, the glass transition temperature (Tg) and melting point of amorphous polyester resin A, amorphous polyester resin B, and crystalline polyester resin C, as well as other components such as mold release agents, are the endothermic peak top temperature and glass transition temperature (Tg) Tg of each subject sample at the second temperature increase, unless otherwise specified.

[Average Particle Size and Average Circularity]

For the measurements of average particle size and average circularity, for example, a flow particle image analyzer (FPIA-3000, manufactured by Sysmex Corporation) can be used. As a specific measurement method, 0.1 ml to 0.5 ml of a surfactant, preferably alkylbenzene sulfonate, is added as a dispersing agent to 100 ml to 150 ml of water from which impurity solids have been previously removed in the container, and approximately 0.1 g to 0.5 g of the sample to be measured is added. The suspension in which the sample is dispersed is subjected to a dispersion step by an ultrasonic disperser for about 1 to 3 minutes, and the average particle size and average circularity are measured by a flow-type particle image analyzer with the dispersion concentration ranging from 3000 particles/μl to 10,000 particles/μl. The particle size is the equivalent circle diameter, and the average particle size is determined by the equivalent circle diameter (number basis). The analytical conditions of the flow particle image analyzer is as follows.
Particle size limited: 0.5 μm≤equivalent circle diameter (number basis)≤200.0 μm
Particle shape limited: 0.93<circularity≤1.00 The average circularity is defined as follows:

(average circularity)=(perimeter of circle equal to projected area)/(perimeter of projected image)

[Measurement of Molecular Weight]

The molecular weight of each component of resin particles can be determined by, for example, the following methods.
Gel Permeation Chromatography (GPC) measuring device: GPC-8220 GPC (manufactured by Tosoh Corporation)
Column: TSKgel SuperHZM-H 15 cm 3 columns (manufactured by Tosoh Corporation)
Temperature: 40° C.
Solvent: THF
Flow rate: 0.35 mL/min
Sample: inject 100 μL of 0.15% by mass sample
Sample preparation: Resin particles are dissolved in tetrahydrofuran THF (Stabilizer included, manufactured by Wako Pure Chemical) at 0.15% by mass, then filtered through a 0.2 μm filter, and the filtrate is used as a sample. 100 μL of the THF sample solution is injected and measured.

When measuring the molecular weight of a sample, the molecular weight distribution of the sample is calculated from the logarithm of the calibration curve made of several monodisperse polystyrene standard samples and the relationship between the count number. Standard polystyrene samples for calibration curves are ShowdexSTANDARD Std. No. S-7300, S-210, S-390, S-875, S-1980, S-10.9, S-629, S-3.0, S-0.580, manufactured by Showa Denko K.K., are used. An RI (refractive index) detector is used for the detector.

<Method of Manufacturing Resin Particles>

A method of producing resin particles according to one embodiment will be described. The method of manufacturing resin particles according to one embodiment includes an oil phase preparation step, an aqueous phase preparation step, a phase transfer emulsification step, a desolvation step, an agglomeration step, and a fusion step, and further includes other steps such as a shelling step, a washing step, a drying step, an annealing step, and an external additive step as necessary.

(Oil Phase Preparation Step)

In the oil phase preparation step, the oil phase is first prepared by dissolving or dispersing resin (amorphous resin, crystalline resin, and the like) which are the raw materials of the resin particles, PET or PBT, and materials such as colorants, prepolymers (precursors of amorphous polyester resin A), waxes, and the like, as needed in an organic solvent. Some of the materials may be added in the agglomeration step described later.

The method of preparing the oil phase is not particularly limited and can be appropriately selected according to the purpose, for example, by gradually adding, dissolving or dispersing a raw material such as resin in an organic solvent while stirring.

When dispersing, a known dispersing machine can be used, for example, a dispersing machine such as a bead mill and a disc mill can be used.

Each raw material used in the oil phase preparation step may be those described in the above <Resin Particles>. These may be used alone or in combination of two or more. At least one of the resins (amorphous resin and crystalline resin) is preferably a biomass-derived resin.

Although the organic solvent is not particularly limited and can be appropriately selected according to the purpose, it is preferable to use a volatile solvent with a boiling point of less than 100° C. because the volatile solvent makes it easier to remove the organic solvent later.

Examples of organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, butyl acetate, methyl ethyl ketone, methyl isobutyl ketone, methanol, ethanol, and isopropyl alcohol. These may be used alone or in combination of two or more.

When the resin to be dissolved or dispersed in the organic solvent is a resin with a polyester skeleton, an ester solvent such as methyl acetate, ethyl acetate, butyl acetate, and the like or a ketone solvent such as methyl ethyl ketone, methyl isobutyl ketone, and the like is preferably used as the organic solvent in terms of high solubility. Among these, methyl acetate, ethyl acetate, or methyl ethyl ketone, which have high solvent removability, are preferably used as organic solvents.

The amount of organic solvent to be used is not particularly limited and can be appropriately selected according to the purpose, but 40 to 300 parts by mass, 60 to 140 parts by mass, and 80 to 120 parts by mass are more preferable with respect to 100 parts by mass of the raw material for resin particles.

(Aqueous Phase Preparation Step)

In the aqueous phase preparation step, the aqueous phase (aqueous medium) is prepared.

The aqueous-based medium is not particularly limited and can be selected from the known ones as appropriate, for example, water, solvents miscible with water, or mixtures thereof. The concentration of the solvent that can be miscible with water is preferably less than or equal to the saturation concentration with respect to the ion-exchanged water used in the phase-transfer emulsification step from the viewpoint of granulation.

Solvents that can be miscible with water are not particularly limited and can be selected from the known solvents, for example, alcohols, dimethylformamide, tetrahydrofuran, cellsorbs, lower ketones, esters, or the like.

Examples of alcohols include methanol, isopropanol, ethylene glycol, or the like.

Examples of lower ketones include acetone or methyl ethyl ketone.

Examples of the esters include ethyl acetate.

These may be used alone or in combination of two or more.

(Phase Transfer Emulsification Step)

In the phase transfer emulsification step, the oil phase obtained in the oil-phase preparation step is microparticulated.

After neutralizing the oil phase, ion-exchange water is added to the neutralized oil phase, and the fine particle dispersion liquid is obtained by phase transfer emulsification, in which the water-in-oil dispersion is transferred to the oil-in-water dispersion liquid.

The phase transfer emulsification is carried out with stirring.

The step is carried out by mixing and dispersing the mixture uniformly using a normal stirrer or a disperser.

As a stirring blade, there is no particular limitation, and a stirring blade can be selected appropriately according to the viscosity of the solution. Examples of stirring blade include low-viscosity stirring blades such as paddles, propellers, and the like; medium-viscosity stirring blades such as anchors, max blends, and the like; and high-viscosity stirring blades such as helical ribbons and the like.

Examples of dispersers include, but are not limited to, ultrasonic dispersers, bead mills, ball mills, roll mills, homo mixers, ultra mixers, dispersion mixers, penetrating high pressure dispersers, colliding high pressure dispersers, porous high pressure dispersers, ultra-high pressure homogenizers, ultrasonic homogenizers, or the like. Regular stirrers and dispersers may be used in combination.

Among these, paddles and anchors are preferably used in that the volume average particle size of the dispersions (oil droplets) can be controlled within the above desirable range.

Either a basic inorganic compound or a basic organic compound may be used as the base for neutralizing the oil phase. Examples of basic inorganic compounds include sodium hydroxide, potassium hydroxide, lithium hydroxide, ammonia, sodium carbonate, sodium bicarbonate, potassium carbonate, potassium bicarbonate, ammonia, and the like. Examples of basic organic compounds include N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, isophorone diamine, and the like.

When the stirring blade is used, the conditions such as the number of revolutions, the stirring time, the stirring temperature, and the like are not particularly limited and can be appropriately selected according to the purpose.

The number of revolutions is not particularly limited and is preferably from 100 rpm to 1,000 rpm, and more preferably from 200 rpm to 600 rpm.

The stirring time and stirring temperature are not particularly limited and may be selected as appropriate according to the purpose.

A dispersing agent may also be used if necessary. The dispersing agent is not particularly limited and can be selected appropriately according to the purpose. Examples of dispersing agents include surfactants, poorly water-soluble inorganic compound dispersants, polymeric protective colloids, and the like. These may be used alone or in combination of two or more. Among these, surfactants are preferably used.

The surfactants are not particularly limited and can be selected appropriately according to the purpose. Examples of surfactants include anionic surfactants, cationic surfactants, nonionic surfactants, amphoteric surfactants, and the like.

The anionic surfactants are not particularly limited and can be selected appropriately according to the purpose. Examples of anionic surfactants include alkylbenzene sulfonates, α-olefin sulfonates, phosphates, and the like. Among these, those having a fluoroalkyl group are preferably used.

(Desolvation Step)

In the desolvation step, the organic solvent is removed from the resulting fine particle dispersion.

To remove the organic solvent from the resulting fine particle dispersion, a method can be employed in which the entire system is stirred and the temperature of the entire system is gradually raised to completely evaporate the organic solvent in the droplets.

Alternatively, the resulting fine particle dispersion can be sprayed into a dry atmosphere with stirring to completely remove the organic solvent in the droplets. In addition, the fine particle dispersion may be reduced in pressure with stirring to evaporate and remove the organic solvent.

Alternatively, the organic solvent may be evaporated and removed by blowing gas while stirring the fine particle dispersion.

These measures may be used alone or in combination.

As the drying atmosphere in which the particulate dispersion is sprayed, various air currents heated to a temperature above the boiling point of the highest boiling solvent used are generally used, including air, nitrogen, carbon dioxide gas, combustion gas, and other heated gases. Short-term treatment of spray dryers, belt dryers, rotary kilns, or the like provides sufficient target quality.

The fine particle dispersion liquid can be obtained by removing the organic solvent from the obtained fine particle dispersion in the above manner.

(Agglomeration Step)

Then, the obtained fine particle dispersion liquid is allowed to agglomerate to a desired particle size while stirring.

Conventional methods can be used to cause agglomeration, such as adding an agglomerating agent or adjusting pH. When an agglomerating agent is added, the agglomerating agent may be added as is, but the agglomerating agent is preferably converted into an aqueous solution so that a localized increase in concentration is avoided. In addition, the agglomerating agent is preferably gradually added while observing the particle size.

The temperature of the dispersion liquid during agglomeration is preferably near the glass transition temperature Tg of the resin used. If the liquid temperature of the fine particle dispersion liquid is too low, agglomeration will not appreciably proceed, resulting in poor efficiency. If the liquid temperature of the fine particle dispersion liquid is too high, the agglomeration rate increases, coarse particles are generated, and the particle size distribution deteriorates.

When the particle size becomes a desired particle size, the agglomeration is stopped. Methods for stopping agglomeration include adding salts or chelating agents with low ionic valence, adjusting the pH, lowering the temperature of the dispersion liquid, and diluting the concentration by adding a large amount of aqueous medium.

The dispersion liquid of resin particles can be obtained by the above method.

In the agglomeration step, a colorant, a crystalline resin, or a release agent may be added. In such cases, the dispersion liquid in which these materials are dispersed in an aqueous media or these materials are mixed with the fine particle dispersion liquid is agglomerated, resulting in obtaining agglomerated particles that the colorant, the crystalline resin, or the release agent is evenly dispersed.

In the present embodiment, it is preferable to use a metal salt of Na with a low ionic value. By replacing Na with the metal used as an agglomerating agent, the agglomeration can be stopped efficiently.

((Agglomerating Agent))

As the agglomerating agent, a general agglomerating agent can be used. An agglomerating agent may be used alone or in combination of two or more.

Metal ions act as cross-linking agents that cross-link the ends of the resin.

For example, metal salts of monovalent metals such as sodium, potassium, and the like; metal salts of divalent metals such as calcium, magnesium, and the like; and metal salts of trivalent metals such as iron, aluminum, and the like can be used.

In the present embodiment, a divalent metal salt is preferably used in order to obtain resin particles with a favorable particle size distribution.

The effect caused by monovalent metal salts is poor. In addition, when biomass resins, amorphous resins having many aromatic ring skeletons, and PET or PBT resins are used, the particle size distribution of resin particles becomes poor if trivalent or higher metal salts with a large structural difference and a fast cross-linking reaction rate is used. Among the divalent metals, the agglomeration of Mg was especially favorable. The amount of divalent metal elements in the resin particles is in a range from 0.05% by mass to 1% by mass, because residual metals in the resin particles deteriorate the chargeability characteristics. When the amount of divalent metal elements in the resin particles is 0.05% by mass or more, the amount of metal used during the agglomeration is sufficient and the agglomeration force is sufficient. As a result, the deterioration of the particle size distribution can be suppressed. When the amount of the divalent metal element in the resin particle is 1% by mass or less, the resin particles can have chargeability characteristics. The type and amount of metal in the resin particles can be adjusted according to the type and amount of an agglomerating agent and a terminating agent, and the washing conditions in the washing step.

(Fusion Step)

In the melting step, the resulting agglomerated particles are then fused by heat treatment to reduce irregularities. The fusion may be accomplished by heating the dispersion of the agglomerated particles while stirring the dispersion of the agglomerated particles. Preferably, the temperature of the liquid is around the temperature exceeding the Tg of the resin being used.

(Shelling Step)

If necessary, shelling may be performed (shelling step). In the shelling step, shell layers are formed on the sphericized particles obtained in the fusion step.

The method of forming the shell layers is not particularly limited and can be appropriately selected according to the purpose. As a method of forming the shell layers, for example, the shell layers can be formed by fabricating spherical particles of the desired particle size in the fusion step, adding the amorphous resin, and repeating the agglomeration and fusion steps.

(Washing and Drying Steps)

In the washing and drying steps, only resin particles are removed from the resin particle dispersion liquid obtained by the above method, followed by washing and drying.

Since the resin particle dispersion liquid obtained by the above-described method contains a sub-material such as agglomerated salt in addition to the resin particles, washing is performed in order to remove only the resin particles from the dispersion liquid. Methods of washing the resin particles include a centrifugal separation method, a vacuum filtration method, and a filter press method. The methods of washing the resin particles are not particularly limited in the present embodiment. A cake body of the resin particles can be obtained by either method. If the resin particles cannot be sufficiently washed in a single operation, the cake obtained can be dispersed in an aqueous solvent again to make a slurry, and the step of removing the resin particles by either of the above methods can be repeated. If the washing is performed by a reduced-pressure filtration or filter press method, an aqueous solvent may be used to penetrate the cake and wash away the secondary materials contained in the resin particles. As the aqueous-based solvent used for this washing, water or a mixture of water and an alcohol such as methanol or ethanol are used. Water is preferably used in view of reducing cost and environmental load caused by, for example, drainage treatment.

Since the washed resin particles contain a large amount of aqueous-based solvent, the resin particles only can be obtained by drying and removing the aqueous-based solvent.

As the drying method, a dryer such as a spray dryer, a vacuum freeze dryer, a vacuum dryer, a static dryer, a mobile dryer, a fluidized dryer, a rotary dryer, a stirred dryer, or the like, can be used. The dried toner particles are preferably dried until the final moisture content is less than 1%. If the colored resin particles after drying are agglomerated and impractical for use, the agglomerated particles may be pulverized using a device such as a jet mill, a Henschel mixer, a super mixer, a coffee mill, an Oster blender, or a hood processor to break up the agglomerated particles.

(Annealing Step)

When crystalline resin is added, the crystalline resin and the amorphous resin are phase separated by annealing after drying, thereby improving fixing property. Specifically, the product should be stored at a temperature around Tg for at least 10 hours.

(External Additive Step)

Other components such as a wax, an external additive agent, an charge controlling agent, cleaning improver, and the like may be added to the resulting resin particles so as to provide fluidity, chargeability characteristics, cleaning property, or the like.

Suitable methods may include, for example, applying an impact to the mixture using blades rotating at a high speed, throwing the mixture into a high-speed airflow to accelerate the mixture, and causing the particles to collide with each other or causing the particles to collide with an impact plate, and the like.

A device to be used for applying the mechanical impact to the mixture can be appropriately selected according to the purpose. For the device, angmill (by Hosokawa micron corporation), a device obtained by modifying I-type mill (by Nippon Pneumatic Mfg. Co., Ltd.) to reduce a pulverizing air pressure, a hybridization system (by Nara machinery Co., Ltd.), Kryptron (trademark registered) (by Kawasaki Heavy Industries, Ltd.), automatic mortar, or the like, may be used.

Thus, the resin particles in one embodiment contain PET or PBT, wherein a concentration of a radioactive carbon isotope ¹⁴C is 10.8 pMC or more, and wherein 0.05% by mass to 1% by mass of divalent metal elements excluding the external additive agent is contained in the resin particles. By including PET or PBT in the resin particles of one embodiment, even if biomass-derived resins are included instead of petroleum-derived resins, the effect of structural differences in biomass-derived resins on the characteristics of the resin particles can be reduced while enhancing environmental responsiveness. In addition, the resin particles in one embodiment contain 0.05% by mass to 1% by mass of divalent metal elements, which enables the resin particles to be mildly agglomerated with each other when the resin particles are agglomerated using a metal salt during the manufacture of the resin particles, so that the resin particles with excellent particle size distribution can be obtained.

Therefore, the resin particles in one embodiment can reduce environmental load, have excellent particle size distribution, and form images with excellent image quality.

The resin particles in one embodiment contain at least one of an amorphous resin and a crystalline resin, and at least one or more of the amorphous resin and the crystalline resin contain a biomass-derived resin, and the total content of the biomass-derived resin and PET or PBT with respect to the total mass of the resin particles can be 50% by mass or more. As a result, the resin particles in one embodiment contain the biomass-derived resin to enhance environmental responsiveness, and the influence of the structural differences of the biomass-derived resin from the petroleum-derived resin on the properties of the resin particles can be surely reduced. Therefore, the resin particles in one embodiment can increase the particle size distribution and provide images with excellent quality more stably while reducing the environmental load.

The resin particles in one embodiment can contain more PET or PBT than biomass-derived resins. Thus, the resin particles in one embodiment can further reduce the influence of the structural differences of the biomass-derived resins from the petroleum-derived resins on the properties of the resin particles.

Among the divalent metal elements in the resin particles in one embodiment, 0.1% by mass to 0.5% by mass of magnesium can be contained in the resin particles. As a result, when the resin particles are agglomerated using the metal salt in manufacturing the resin particles, the resin particles can be agglomerated more reliably and mildly, so that the resin particles with a better particle size distribution can be reliably obtained.

The resin particles according to one embodiment contain sodium, and magnesium in the divalent metal elements is more than the sodium, and a content of the sodium may exceed 0.05% by mass. As a result, when the resin particles according to one embodiment are agglomerated by using the metal salt in manufacturing the resin particles, the agglomeration of the resin particles can be further mildly performed, so that the resin particles with a better particle size distribution can be reliably obtained.

Since the resin particles in one embodiment have the above characteristics, the resin particles can be effectively used as materials for image formation such as a toner, a developer, a toner set, a toner housing unit, and an image forming apparatus.

<Toner>

The toner according to one embodiment contains the resin particles according to one embodiment and may be formed from the resin particles of one embodiment.

By using the resin particles of one embodiment as a toner, the environmental load can be reduced, and even if plant-derived resin is used, the toner having excellent low-temperature fixability and chargeability characteristics can be achieved, and excellent image quality can be provided.

<Developer>

The developer of one embodiment includes the toner of one embodiment and may include other components, such as carriers, which are selected as appropriate, as needed. As a result, the toner having excellent transferability, chargeability characteristics, and the like can be achieved, and high-quality images can be stably formed.

The developer may be a single-component developer or a two-component developer. In the case where the developer is used for a high-speed printer, or the like, corresponding to the recent enhancement in the information processing speed, from a point of enhancing the lifetime of the printer, the two-component developer is preferably used.

In the case where the above-described developer is used as single component developer, even when the toner is consumed and supplied repeatedly, the toner exhibits little variation in the particle size, little filming on the developing roller, and little adhesion to a member such as a blade that forms a thin layer of the toner. Thus, even when the toner is stirred for a long time, excellent and stable developing property and image are obtained.

If the developer is used in the two-component developer, it can be mixed with a carrier as a developer. If the toner is used in the two-component developer, even when the toner is consumed and supplied repeatedly for a long time, variation in the particle size of the toner is small; and even when the toner is stirred for a long time in the developing device, excellent and stable developing property and image are obtained.

The content of the carrier in the two-component developer can be appropriately determined according to the purpose. The content preferably is within a range from 90 parts by mass to 98 parts by mass, and more preferably is within a range from 93 parts by mass to 97 parts by mass relative to 100 parts by mass of the two-component developer.

The developer according to the embodiment of the present application can preferably be used to form images using the conventional electrophotography, such as a magnetic monocomponent development method, a nonmagnetic monocomponent development method, or a two-component development method.

[Carrier]

The carrier is not particularly limited and can be appropriately selected according to the purpose, but the carrier preferably has a core material and a resin layer (coating layer) covering the core material.

(Core)

The material of core is not particularly limited, and can be appropriately selected according to the purpose. Suitable materials of the core may include, for example, manganese-strontium based materials with a magnetization that is within a range from 50 emu/g to 90 emu/g and manganese-magnesium based materials with magnetization that is within a range from 50 emu/g to 90 emu/g. Moreover, to secure an image density, iron powder with a magnetization of 100 emu/g or greater, and a high magnetization material such as magnetite with magnetization that is within a range from 75 emu/g to 120 emu/g are preferably used. Moreover, a low magnetization material such as copper-zinc based material with magnetization that is within a range from 30 emu/g to 80 emu/g is preferably used, because it is possible to relax the impact to the photoconductor of the developer, in a form of brush, and it is advantageous for improving the image quality. The above-described materials may be used singly, or a combination of two or more materials may be used.

The volume average particle diameter of the core is not particularly limited, and can be appropriately determined according to the purpose. The volume average particle diameter preferably is within a range from 10 μm to 150 μm, and more preferably is within a range from 40 μm to 100 μm. When the volume average particle diameter is 10 μm or more, it is possible to effectively suppress problems such as increases in the amount of fine powders in the carrier, decreases in the magnetization per individual particle, and scattering of the carriers. Meanwhile, when the volume average particle diameter is 150 μm or less, it is possible to effectively suppress problems such as decreases in the specific surface area, occurrence of scattering of the toner, and poor reproduction of solid image portion in a full-color image including a lot of solid image portions.

(Resin Layer)

The resin layer can contain resin and other components as needed. As the resin used for the resin layer, a known material capable of imparting the necessary chargeability characteristics can be used. Specifically, the resin layers are preferably formed from silicone resin, acrylic resin, or a combination thereof. The composition for forming the resin layer preferably contains a silane coupling agent.

The average thickness of the resin layer is preferably in a range from 0.05 μm to 0.50 μm.

<Developer Housing Container>

A developer housing container according to one embodiment stores the developer of one embodiment. The developer housing container is not particularly limited, and known containers can be appropriately selected for the intended purpose. The developer housing container has a container body and a cap.

In addition, although the size, shape, structure, material, and the like of the container body are not particularly limited, the shape is preferably cylindrical and the like. The shape is particularly preferable that the inner circumference has spiral-shaped irregularities, and that by rotating it, the content, developer, can migrate to the outlet side, and that some or all of the spiral-shaped irregularities have a bellows function. Furthermore, the material is not particularly limited, but the material is preferable to have good dimensional accuracy, for example, resin materials such as polyester resin, polyethylene resin, polypropylene resin, polystyrene resin, polyvinyl chloride resin, polyacrylic acid, polycarbonate resin, ABS resin, polyacetal resin, and the like.

The developer housing container is easy to store, transport, and so on, and is excellent in handling. Therefore, the developer housing container can be detachably attached to an image forming apparatus, process cartridge, and the like, described later, and used for replenishing the developer.

<Toner Housing Unit>

A toner housing unit according to the embodiment of the present application can store the toner of the embodiment of the present application. The toner housing unit according to the embodiment of the present application includes: a unit having a function of housing a toner; and a toner housed in the unit. Examples of the toner housing unit include, for example, a toner housing container, a developing unit, and a process cartridge.

The toner housing container refers to a container that stores a toner.

The developing unit refers to a unit that stores a toner and has a developing unit.

A process cartridge is one that includes at least an electrostatic latent image bearer and a developing device that are integrated, houses a toner, and is detachably attached to the image forming apparatus. The process cartridge may further be equipped with at least one selected from an chargeability device, an exposure device, a cleaning device, and the like.

The toner according to one embodiment is stored in the toner housing unit of one embodiment. By mounting the toner housing unit according to one embodiment on the image forming apparatus to form an image, an image formation is performed using the toner of one embodiment. Therefore, the toner having excellent low-temperature fixability, chargeability characteristics can be achieved, and high quality images can be obtained.

<Image Forming Apparatus>

The image forming apparatus according to one embodiment has an electrostatic latent image bearer, an electrostatic latent image forming part that forms an electrostatic latent image on the electrostatic latent image bearer, and a developing part that develops the electrostatic latent image formed on the electrostatic latent image bearer using the toner to form a toner image, and can have other configurations as needed.

The image forming apparatus according to one embodiment is more preferably equipped with a transferring part for transferring the toner image onto a recording medium and a fixing part for fixing the transferred image onto the surface of the recording medium, in addition to the electrostatic latent image bearer, the electrostatic latent image forming part, and the developing part described above.

The toner according to one embodiment is used in the developing part. Preferably, a toner image may be formed by using the developer containing the toner of one embodiment and, if necessary, other components such as carriers or the like.

(Electrostatic Latent Image Bearer)

A material, a shape, a structure, a size, and the like of the electrostatic latent image bearer (sometimes referred to as “electrophotographic photoconductor” or “photoconductor”) are not particularly limited, and can be appropriately selected from the conventional electrostatic latent image bearers. The materials of the electrostatic latent image bearer include, for example, inorganic photoconductors such as amorphous silicon, selenium, an and the like; organic photoconductors (OPC) such as polysilane, phthalo polymethine, and the like. Among them, amorphous silicon is preferably used from the viewpoint of longevity, and organic photoconductor (OPC) is preferably used from the viewpoint of obtaining more high resolution images.

As the amorphous silicon photoconductor, for example, a photoconductor having a photoconductive layer made of a-Si can be used by heating a support to 50 to 400° C. and forming a film on the support by vacuum deposition method, sputtering method, ion plating method, thermal Chemical vapor deposition (CVD) method, photo CVD method, plasma CVD method, or the like. Among these, the plasma CVD method, in which source gas is decomposed by direct current or radio frequency or microwave glow discharge to form a deposited a-Si film on the support, is preferably used.

The shape of the electrostatic latent image bearer is not particularly limited and can be selected appropriately according to the purpose, but a cylindrical shape is preferably used. The outer diameter of the cylindrical electrostatic latent image bearer is not particularly limited and can be selected appropriately according to the purpose. The outer diameter of the cylindrical electrostatic latent image bearer is preferably in a range from 3 mm to 100 mm, more preferably in a range from 5 mm to 50 mm, and particularly preferably 10 mm to 30 mm.

(Electrostatic Latent Image Forming Part)

The electrostatic latent image forming part is not particularly limited as long as the electrostatic latent image forming part is a means for forming an electrostatic latent image on the electrostatic latent image bearer, and can be selected appropriately according to the purpose. The electrostatic latent image forming part is provided with, for example, a charging member (charger) that uniformly charges the surface of the electrostatic latent image bearer and an exposure member (exposure device) that exposes the surface of the electrostatic latent image bearer in an image-like manner.

Chargers are not particularly limited and can be appropriately selected according to the purpose. Examples of chargers include contact chargers equipped with conductive or semiconducting rolls, brushes, films, rubber blades, and the like; and non-contact chargers such as corotrons, scorotrons, and the like using corona discharge.

The shape of the chargers can be any shape such as a magnetic brush, a fur brush, and the like, in addition to a roller and can be selected according to the specifications and shape of the image forming apparatus.

The charger is preferably arranged in contact or non-contact with the electrostatic latent image bearer, and charges the surface of the electrostatic latent image bearer by applying a superimposed direct current and alternating current voltage. The charger is preferably an charged roller arranged in close proximity to the electrostatic latent image bearer in a non-contact manner via a gap tape and charges the surface of the electrostatic latent image bearer by superimposing a direct current and an alternating current voltage on the charged roller.

Although the charger is not limited to a contact type charger. The charger is preferably a contact type charger that includes a charged member from a viewpoint of obtaining an image forming apparatus with reduced ozone generated from the charger.

The exposure device is not particularly limited as long as the exposure device can expose with an image to be formed onto the surface of the electrostatic latent image bearer charged by the charger, and can be appropriately selected according to the purpose. The exposure device includes, for example, various types of exposure devices such as a copying optical system, a rod lens array system, a laser optical system, a liquid crystal shutter optical system, and the like.

The light source used for the exposure device is not particularly limited and can be selected appropriately according to the purpose, for example, fluorescent lamps, tungsten lamps, halogen lamps, mercury lamps, sodium lamps, light emitting diodes (LED), semiconductor lasers (LD), electroluminescence (EL), and other luminous materials in general.

In addition, various filters such as a sharp cut filter, a bandpass filter, a near-infrared cut filter, a dichroic filter, an interference filter, and a light balancing filter, and the like can be used to irradiate only light in the desired wavelength range.

The exposure device may employ a light backplane system that exposes the image from the backside of the electrostatic latent image bearer.

(Developing Part)

The developing part is not particularly limited and can be selected appropriately according to the purpose, if the visible image can be formed by developing the electrostatic latent image formed on the electrostatic latent image bearer. For example, the developing part can suitably be equipped with a developing device that contains toner and can apply toner to the electrostatic latent image in a contact or non-contact manner, and the developing device with a toner-containing container is preferably used.

The developing device be a monochromatic developing device or a multicolor developing device. As the developing device, for example, a developing device having a stirrer for charging toner by friction stirring and a magnetic field generating part fixed inside the developing device, and a developer carrier (for example, a magnet roller) capable of being rotated by carrying a developer containing toner on the surface is suitably used.

(Transferring Part)

The transferring part is preferably configured to include a primary transferring part that transfers a visible image onto an intermediate transfer body to form a composite transfer image and a secondary transferring part that transfers the composite transfer image onto a recording medium. The intermediate transfer body is not particularly limited and can be selected from among known transfer bodies according to the purpose, and, for example, a transfer belt is preferably used.

The transferring part (primary transferring part and secondary transferring part) preferably has at least a transferring device that peels and charges the visible image formed on the electrostatic latent image bearer (photoconductor) onto the recording medium side. The transferring part may be one or two or more.

Examples of transferring devices include corona transfer devices by corona discharge, transfer belts, transfer rollers, pressure transfer rollers, adhesive transfer devices, and the like.

The recording medium is typically plain paper. The recording medium is not particularly limited as long as the recording medium is capable of transferring an unfixed image after developing an image, and any of the known recording media (recording paper) can be selected according to the purpose. PET bases for OHP and other materials can also be used.

(Fixing Part)

The fixing part is not particularly limited, and can be appropriately selected according to the purpose. The fixing part is preferably a conventional heating and pressurizing part. Examples of the heating and pressurizing parts include a combination of a heating roller and a pressurizing roller, a combination of a heating roller, a pressuring roller, an endless belt, and the like.

The fixing part preferably has a heating body that includes a heating element, a film that contacts with the heating body, and a pressurizing member that heat-pressurizes with the heating body through the film. The fixing part is a heating and pressurizing part that can be heat-fixed by passing a recording medium in which an unfixed image is formed between the film and the pressurizing member.

Heating in the heating and pressurizing part is preferably from 80 to 200° C., in general.

The surface pressure in the heating and pressurizing part is not particularly limited and can be appropriately selected according to the purpose. The surface pressure is preferably in a range from 10 N/cm² to 80 N/cm².

In the present embodiment, for example, a known optical fixing device may be used along with or instead of the fixing part according to the purpose.

(Others)

The image forming apparatus according to one embodiment may be provided with other parts, such as a static eliminating part, a recycling part, a control part, and the like.

((Static Eliminating Part))

The static eliminating part is not particularly limited, and only if a static elimination bias can be applied to the electrostatic latent image bearer, the static eliminating part can be suitably selected from known static eliminating devices, and for example, a static elimination lamp and the like can be suitably used.

((Cleaning Part))

The cleaning part can remove the toner remaining on the electrostatic latent image bearer, and the cleaning part can be selected appropriately from among known cleaners. Examples of the cleaning parts include a magnetic brush cleaner, an electrostatic brush cleaner, a magnetic roller cleaner, a blade cleaner, a brush cleaner, a web cleaner, and the like.

The image forming apparatus according to one embodiment can improve cleanability by having the cleaning part. That is, by controlling the adhesive force between the toners, the fluidity of the toner is controlled and the cleanability can be improved. In addition, by controlling the characteristics of the toner after deterioration, excellent cleaning quality can be maintained even under harsh conditions such as long-life and high temperature and humidity. Furthermore, the external additive agent can be sufficiently freed from the toner on the photoconductor. Therefore, high cleanability can be achieved by forming a deposit layer (dam layer) of the external additive agent at the cleaning blade nip part.

((Recycling Part))

The recycling part is not particularly limited, but includes known transport means.

((Controlling Part))

The controlling part can control the movement of the above parts. As for the controlling part, if the movement of the above parts can be controlled, the controlling part is not particularly limited, and can be selected appropriately according to the purpose. For example, controlling devices such as sequencers and computers can be used.

The image forming apparatus of one embodiment can form images using the toner of one embodiment. Therefore, power consumption can be reduced and high-quality images can be stably provided.

<Method of Forming Images>

The method of forming images according to one embodiment includes an electrostatic latent image forming step of forming an electrostatic latent image on an electrostatic latent image bearer and a developing step of developing the electrostatic latent image using the toner to form a toner image, and may include other steps as needed. The method of forming images can be suitably performed by the image forming apparatus, the electrostatic latent image forming step can be suitably performed by the electrostatic latent image forming part, the developing step can be suitably performed by the developing part, and the other steps can be suitably performed by the other parts.

In addition, the method of forming images according to one embodiment more preferably includes a transferring step of transferring the toner image onto a recording medium and a fixing step of fixing the transferred image onto the surface of the recording medium, in addition to the above electrostatic latent image forming step and developing step.

In the developing step, the toner according to one embodiment is used. Preferably, a toner image may be formed by using a developer containing the toner of one embodiment and, if necessary, other components such as carriers.

The electrostatic latent image forming step is a step of forming an electrostatic latent image on an electrostatic latent image bearer and includes an charging step of charging the surface of the electrostatic latent image bearer and an exposure step of exposing the surface of the charged electrostatic latent image bearer to form an electrostatic latent image. Chargeability can be performed, for example, by applying a voltage to the surface of the electrostatic latent image bearer using a charger. Exposure can be performed, for example, by image-like exposure of the surface of the electrostatic latent image bearer using the exposure device. The formation of the electrostatic latent image can be performed by, for example, uniformly charging the surface of the electrostatic latent image bearer, followed by exposing as image-like exposure by the electrostatic latent image forming part.

The developing step is a step of forming a visible image by sequentially developing an electrostatic latent image with a multi-color toner. The formation of the visible image can be carried out, for example, by developing the electrostatic latent image using the toner by the developing device.

In the developing device, for example, the toner and the carrier are mixed and stirred, and the toner is charged by friction at that time, and is held on the surface of the rotating magnet roller in the form of brush. The magnet roller is located near the electrostatic latent image bearer (photoconductor), a part of the toner constituting the magnetic brush formed on the surface of the magnet roller moves to the surface of the electrostatic latent image bearer (photoconductor) by the electric attraction force. As a result, the electrostatic latent image is developed by the toner to form a visible image by the toner on the surface of the electrostatic latent image bearer (photoconductor).

The transferring step is the step of transferring a visible image onto a recording medium. The transferring step is preferably performed using an intermediate transfer body, and after primary transfer of the visible image onto the intermediate transfer body, a secondary transfer of the visible image onto the recording medium is performed. The transferring step is more preferably performed using two or more toners, preferably full color toners, and includes a first transferring step in which the visible image is transferred onto the intermediate transfer body to form a composite transfer image, and a second transferring step in which the composite transfer image is transferred onto the recording medium. Transfer can be performed, for example, by charging the electrostatic latent image bearer (photoconductor) with a transfer charger for the visible image by a transferring part.

The fixing step is a step of fixing the visible image transferred onto the recording medium by using a fixing device, and may be performed for each color developer every time the image is transferred onto the recording medium, or simultaneously for each color developer in a laminated state.

The method of forming images according to one embodiment may further include other steps selected as appropriate, such as a static elimination step, a cleaning step, a recycling step, and the like.

The static elimination step is a step of applying a static elimination bias to the electrostatic latent image bearer to eliminate static electricity, and can be preferably performed by the static eliminating part.

The cleaning step is a step of removing the toner remaining on the electrostatic latent image bearer, and can be performed more favorably by the cleaning part.

The recycling step is a step of having the developing part recycle the toner removed by the cleaning step, and can be performed more favorably by the recycling part.

The method of forming images according to one embodiment can perform image formation using the toner according to one embodiment, and power consumption can be reduced and high-quality images can be stably provided.

### One Embodiment of Image Forming Apparatus

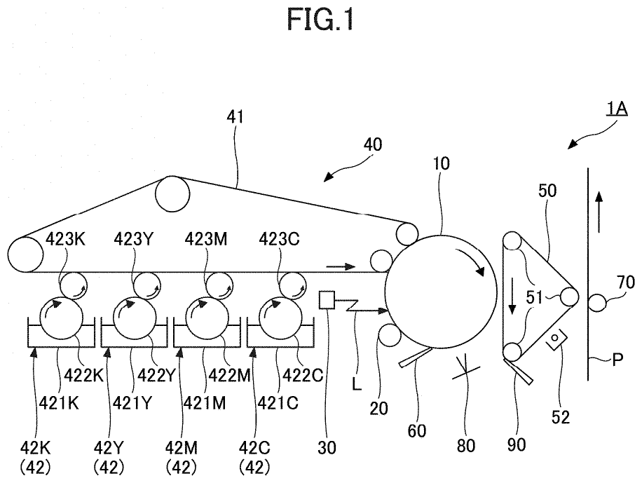

Next, one embodiment of the image forming apparatus according to one embodiment will be described with reference to FIG. 1. FIG. 1 is a schematic configuration diagram illustrating an example of an image forming apparatus according to an embodiment. As illustrated in FIG. 1, an image forming apparatus 1A is equipped with a photoconductor drum 10 which is an electrostatic latent image bearer, a charging roller 20 which is an charging part, an exposure device 30 which is an exposing part, a developing device 40 which is a developing part, an intermediate transfer body (intermediate transfer belt) 50, a cleaning device 60 which is a cleaning part, a transfer roller 70 which is a transferring part, a static elimination lamp 80 which is a static eliminating part, and an intermediate transfer body cleaning device 90.

The intermediate transfer body 50 is an endless belt stretched by three rollers 51 placed inside and designed to be movable in the direction, shown by arrow, by three rollers 51. Some of the three rollers 51 also function as transfer bias rollers capable of applying a predetermined transfer bias (primary transfer bias) to the intermediate transfer body 50. In the vicinity of the intermediate transfer body 50, the intermediate transfer body cleaning device 90 is placed. In the vicinity of the intermediate transfer body 50, the transfer roller 70 is placed opposite to the intermediate transfer body 50, and the transfer bias (secondary transfer bias) can be applied to transfer (secondary transfer) the developed image (toner image) to transfer (secondary transfer) a transfer paper P as a recording medium. Around the intermediate transfer body 50, a corona charger 52 for applying an electric charge to the toner image on the intermediate transfer body 50 is placed between a contact part between the photoconductor drum 10 and the intermediate transfer body 50 and the contact part between the intermediate transfer body 50 and the transfer paper P in the rotational direction of the intermediate transfer body 50.

The developing device 40 is configured by a developing belt 41 as a developer carrier and a developing unit 42 attached to the periphery of the developing belt 41.

The developing belt 41 is an endless belt stretched by a plurality of belt rollers and can be moved in the direction shown by the arrow in the figure. Furthermore, a part of the developing belt 41 is in contact with the photoconductor drum 10.

The developing unit 42 is configured by a black (Bk) developing unit 42K, a yellow (Y) developing unit 42Y, a magenta (M) developing unit 42M, and a cyan (C) developing unit 42C.

The black developing unit 42K includes a developer housing part 421K, a developer supply roller 422K, and a developing roller (developer carrier) 423K. The yellow developing unit 42Y includes a developer housing part 421Y, a developing supply roller 422Y, and a developing roller 423Y. The magenta developing unit 42M includes a developer housing part 421M, a developer supply roller 422M, and a developing roller 423M. The cyan developing unit 42C includes a developer housing part 421C, a developer supply roller 422C, and a developing roller 423C.

Next, a method of forming an image using the image forming apparatus 1A will be described. First, the surface of the photoconductor drum 10 is uniformly charged using the charged roller 20, and then expose an exposure light L to the photoreceptor drum 10 using the exposure device 30 to form an electrostatic latent image. Then, the electrostatic latent image formed on the photoconductor drum 10 is developed with the toner supplied from the developing device 40 to form a toner image. Furthermore, the toner image formed on the photoconductor drum 10 is transferred (primary transfer) onto the intermediate transfer body 50 by the transfer bias applied from the roller 51, and then transferred (secondary transfer) onto the transfer paper P supplied by a paper feed part (not shown) by the transfer bias applied from the transfer roller 70. On the other hand, the photoconductor drum 10, on which the toner image is transferred to the intermediate transfer body 50, is eliminated by the static elimination lamp 80 after the toner remaining on the surface is removed by the cleaning device 60. The residual toner on the intermediate transfer body 50 after image transfer is removed by the intermediate transfer body cleaning device 90.

After the transferring step is completed, the transfer paper P is transported to a fixing unit, in which the toner image transferred above is fixed on the transfer paper P.

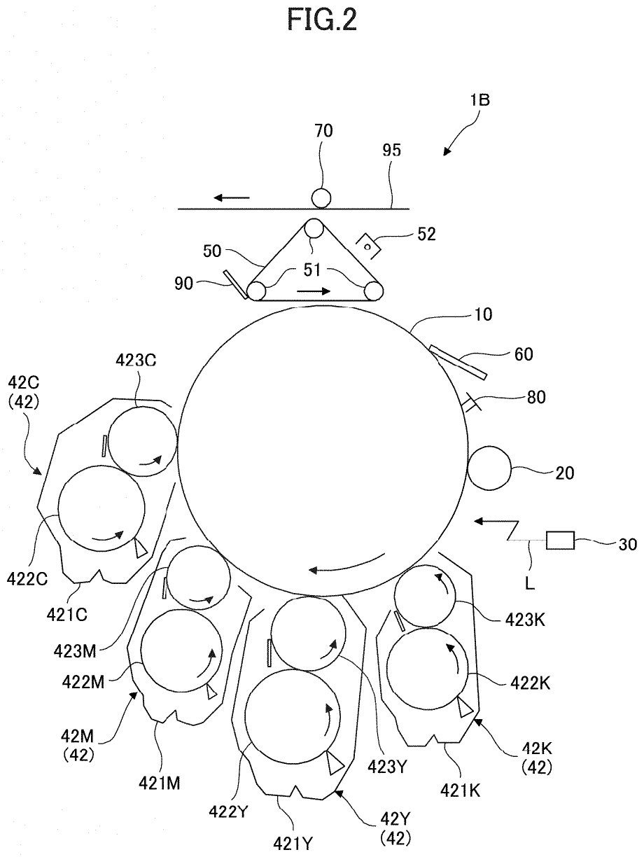

FIG. 2 is a schematic configuration diagram illustrating another example of an image forming apparatus according to one embodiment. As illustrated in FIG. 2, the image forming apparatus 1B has the same configuration as the image forming apparatus 100A in the image forming apparatus 100A illustrated in FIG. 1 except that the developing unit 42 (Black developing unit 42K, yellow developing unit 42Y, magenta developing unit 42M, and cyan developing unit 42C) is arranged directly facing each other around the photoconductor drum 10 without providing the developing belt 41.

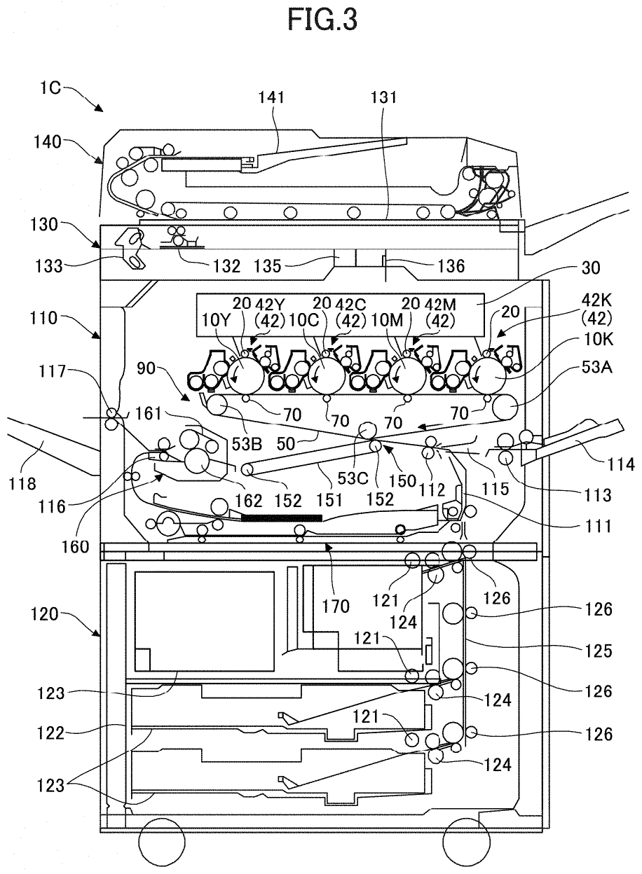

FIG. 3 is a schematic configuration diagram illustrating another example of an image forming apparatus according to one embodiment. As illustrated in FIG. 3, the image forming apparatus 1C is a tandem type color image forming apparatus and is equipped with a copying machine body 110, a paper feeding table 120, a scanner 130, an automatic document feeder (ADF) 140, a secondary transfer device 150, a fixing device 160 which is a fixing part, and a sheet reversing device 170.

An endless belt-shaped intermediate transfer body 50 is provided at the center of the copying machine body 110. The intermediate transfer body 50 is an endless belt stretched over three rollers 53A, 53B, and 53C and can move in the direction shown by the arrow in FIG. 3. In the vicinity of the roller 53B, the intermediate transfer body cleaning device 90 is placed to remove toner remaining on the intermediate transfer body 50 on which the toner image has been transferred to the recording paper. The developing unit 42 (Yellow (Y) developing unit 42Y, cyan (C) developing unit 42C, magenta (M) developing unit 42M, and black (Bk) developing unit 42K), which is a tandem type developing device, is placed opposite to and opposed with the intermediate transfer body 50 stretched by the rollers 53A and 53B along the conveyance direction.

The exposure device 30 is placed in the vicinity of the developing unit 42. Further, the secondary transfer device 150 is placed on the side opposite to the side where the developing unit 42 of the intermediate transfer body 50 is placed. The secondary transfer device 150 is equipped with a secondary transfer belt 151. The secondary transfer belt 151 is an endless belt stretched over a pair of rollers 152, and the recording paper conveyed on the secondary transfer belt 151 and the intermediate transfer body 50 can contact between the roller 53C and the roller 152.

In addition, the fixing device 160 is placed in the vicinity of the secondary transfer belt 151. The fixing device 160 is equipped with a fixing belt 161, which is an endless belt stretched over a pair of rollers, and a pressure roller 162, which is placed and pressed against the fixing belt 161.

In the vicinity of the secondary transfer belt 151 and the fixing device 160, a sheet reversing device 170 is placed to reverse the recording paper when an image is formed on both sides of the recording paper.

Next, a method of forming a full-color image using an image forming apparatus 1C will be described. First, a color document is set on a document stand 141 of the automatic document feeder (ADF) 140, or, the ADF 140 is opened, the color document is set on an exposure glass 131 of the scanner 130, and the ADF 140 is closed.

In a case where a color document is set in the automatic document feeder 140 and a start switch (not shown) is pressed, and the color document is transported and moved to the exposure glass 131 and moved onto the exposure glass. Then, the scanner 130 is driven, and a first running body 132 and a second running body 133 equipped with light sources are driven. On the other hand, when a document is set on the exposure glass 131, the scanner 130 is driven to run the first running body 132 and the second running body 133 equipped with the light sources. At this time, the color document (color image) is read and black, yellow, magenta, and cyan image information is obtained by reflecting the light from the document surface emitted from the first running body 132 by the mirror on the second running body 133 and then receiving the light at a reading sensor 136 through an imaging lens 135.

The image information of each color is transmitted to each color developing unit (yellow developing unit 42Y, cyan developing unit 42C, magenta developing unit 42M, and black developing unit 42K) to form a toner image of each color.

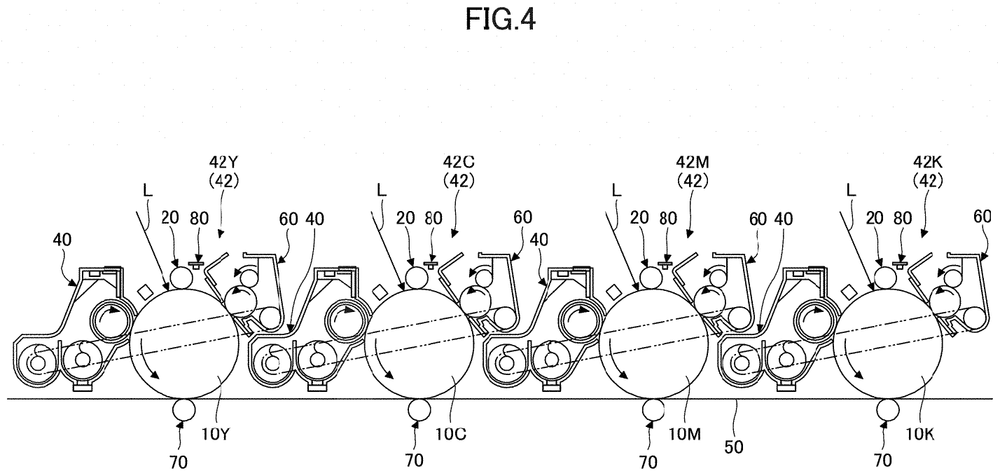

FIG. 4 is a partially enlarged view of the image forming apparatus of FIG. 3. As illustrated in FIG. 4, each developing unit (yellow developing unit 42Y, cyan developing unit 42C, magenta developing unit 42M, and black developing unit 42K) is equipped with a photoconductor drum 10 (photoconductor drum for black 10K, photoconductor drum for yellow 10Y, photoconductor drum for magenta 10M, and photoconductor drum for cyan 10C); a charged roller 20 which is a charging part for uniformly charging the electrostatic latent image bearer 10; the exposure device 30 which exposes an exposure light L on the photoconductor drum 10 based on image information of each color and forms an electrostatic latent image of each color on the photoconductor drum 10; the developing device 40 which is a developing part for developing an electrostatic latent image with a developer of each color and forming a toner image of each color; a transfer charger 62 for transferring a toner image onto the intermediate transfer body 50; the cleaning device 60; and the static elimination lamp 80.

Toner images of each color formed in each color developing unit (yellow developing unit 42Y, cyan developing unit 42C, magenta developing unit 42M, and black developing unit 42K) are sequentially transferred (primary transfer) onto the intermediate transfer body 50 that is stretched and moved by the rollers 53A, 53B, and 53C. Then, the toner images of each color are superimposed on the intermediate transfer body 50 to form a composite toner image.

On the other hand, in the paper feed table 120, one of the paper feed rollers 121 is selectively rotated to feed the recording paper from one of the paper feed cassettes 123 provided in a paper bank 122 in multiple stages. The recording paper is separated one by one by separation rollers 124 and delivered to a paper feed path 125, conveyed by conveyance rollers 126, guided to a paper feed path 111 in a copying machine body 110, and stopped by abutting against a pair of resist roller 112. Alternatively, a manual feed roller 113 is rotated to feed out the recording paper on a manual feed tray 114, the paper is separated one by one by the manual feed roller 113, guided to a manual feed path 115, and stopped by abutting against the resist roller 112.

The resist roller 112 is generally used grounded, but may be used with a bias applied to remove paper dust from the recording paper.

Then, the resist roller 112 is rotated in timing with the composite toner image formed on the intermediate transfer body 50, the recording paper is sent out between the intermediate transfer body 50 and the secondary transfer belt 151, and the composite toner image is transferred (secondary transfer) onto the recording paper. Toner remaining on the intermediate transfer body 50 onto which the composite toner image has been transferred is removed by the intermediate transfer body cleaning device 90.

After the recording paper onto which the composite toner image has been transferred is conveyed by the secondary transfer belt 151, the composite toner image is fixed on the recording paper by the fixing device 160.

Then, the transfer path of the recording paper is switched by a switching pawl 116, and the recording paper is discharged onto a paper discharge tray 118 by a discharge roller 117. Alternatively, the transfer path of the recording paper is switched by the switching pawl 116, inverted by the sheet reversing device 170, guided again by the secondary transfer belt 151, an image is formed on the back of the recording paper in the similar manner, and then the recording paper is discharged by the discharge roller 117 onto the paper discharge tray 118.

<Process Cartridge>

The process cartridge according to one embodiment is formed detachably attached to various image forming apparatuses and has an electrostatic latent image bearer that carries an electrostatic latent image and a developing part that develops the electrostatic latent image bearer on the electrostatic latent image bearer with the developer according to one embodiment to form a toner image, and may have other configurations as needed.

Since the electrostatic latent image bearer is similar to the electrostatic latent image bearer of the image forming apparatus described above, details are omitted.

The developing part includes a developer housing container for storing the developer according to one embodiment and a developer carrier for carrying and transporting the developer stored in the developer housing container. The developing part may further have a regulating member or the like to regulate the thickness of the developer to be carried.

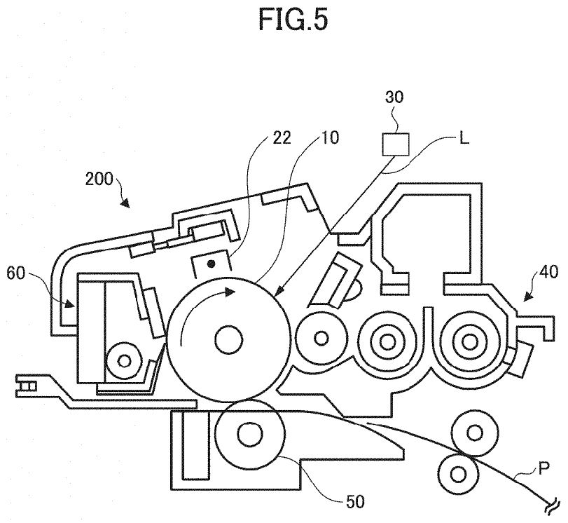

FIG. 5 illustrates an example of the process cartridge according to one embodiment. As illustrated in FIG. 5, an image forming apparatus process cartridge 200 includes the photoconductor drum 10, a corona charger 22 which is a charging part, the developing device 40, the cleaning device 60, and the transfer roller 70.

### EXAMPLES

Hereinafter, Examples and Comparative Examples are indicated to further illustrate the embodiments, but the embodiments are not limited by these Examples and Comparative Examples.

### Production Example A-1: Synthesis of Amorphous Polyester Resin A-1

### Synthesis of Prepolymer A-1

3-methyl-1,5-pentanediol, isophthalic acid, and plant-derived sebacic acid were charged into a reaction vessel equipped with a cooling tube, an agitator, and a nitrogen introduction tube together with titanium tetraisopropoxide (1,000 ppm relative to the resin component) so that the molar ratio of hydroxyl and carboxyl groups, OH/COOH, was 1.1; the diol component was 100 mol, of 3-methyl-1,5-pentanediol; the dicarboxylic acid component was 73 mol % of isophthalic acid and 23 mol % of sebacic acid; and the amount of trimethylolpropane in the total monomer was to be 1.5 mole. After that, the temperature was raised to 200° C. for about 4 hours, and then the temperature was raised to 230° C. for 2 hours, and the reaction was carried out until the effluent disappeared. Then, the reaction was continued for 5 hours under a reduced pressure of 10 to 15 mmHg to obtain an intermediate polyester A-1.

Then, the obtained an intermediate polyester A-1 and isophorone diisocyanate (IPDI) were charged into the reaction vessel equipped with a cooling tube, an agitator, and a nitrogen introduction tube, at a molar ratio (isocyanate group of IPDI/hydroxyl group of the intermediate polyester) of 2.0, diluted to a 50% of ethyl acetate solution with ethyl acetate, and reacted at 150° C. for 4 hours to obtain a prepolymer A-1.

### Synthesis of Amorphous Polyester Resin A-1

The obtained prepolymer A-1 was stirred in the reaction vessel equipped with a heating device, an agitator, and a nitrogen introduction tube, and an amount of ketimine compound 1 in which the amount of amine in the ketimine compound 1 was equimolar to the amount of isocyanate in the prepolymer A-1 was added dropwise to the reaction vessel, and the prepolymer extension product was taken out from the reaction vessel after stirring at 45° C. for 10 hours. The resulting prepolymer extension product was dried under reduced pressure at 50° C. until the residual amount of ethyl acetate was to be 100 ppm or less to obtain an amorphous polyester resin A-1. The obtained amorphous polyester resin A-1 had a glass transition temperature (Tg) of −51° C. and a weight-average molecular weight (Mw) of 17,000.

### Production Example A-2: Synthesis of Amorphous Polyester Resin A-2

### Synthesis of Prepolymer A-2

3-methyl-1,5-pentanediol, isophthalic acid, and adipic acid were charged into a reaction vessel equipped with a cooling tube, an agitator, and a nitrogen introduction tube together with titanium tetraisopropoxide (1,000 ppm relative to the resin component) so that the molar ratio of hydroxyl and carboxyl groups, OH/COOH, was to be 1.1; the diol component was 100 mol % of 3-methyl-1,5-pentanediol; the dicarboxylic acid component was 50 mol % of isophthalic acid and 50 mol % of adipic acid; and the amount of trimethylolpropane in the total monomer was to be 1.5 mole. After that, the temperature was raised to 200° C. for about 4 hours, and then the temperature was raised to 230° C. for 2 hours, and the reaction was carried out until the effluent disappeared. Then, the reaction was continued for 5 hours under a reduced pressure of 10 to 15 mmHg to obtain an intermediate polyester A-2.

Then, the obtained an intermediate polyester A-2 and isophorone diisocyanate (IPDI) were charged into the reaction vessel equipped with a cooling tube, an agitator, and a nitrogen introduction tube, at a molar ratio (isocyanate group of IPDI/hydroxyl group of the intermediate polyester) of 2.0, diluted to a 50% of ethyl acetate solution with ethyl acetate, and reacted at 150° C. for 4 hours to obtain a prepolymer A-2.

### Synthesis of Amorphous Polyester Resin A-2

The obtained prepolymer A-2 was stirred in the reaction vessel equipped with a heating device, an agitator, and a nitrogen introduction tube, and an amount of ketimine compound 1 in which the amount of amine in the ketimine compound 1 was equimolar to the amount of isocyanate in the prepolymer A-2 was added dropwise to the reaction vessel, and the prepolymer extension product was taken out from the reaction vessel after stirring at 45° C. for 10 hours. The resulting prepolymer extension product was dried under reduced pressure at 50° C. until the residual amount of ethyl acetate was to be 100 ppm or less to obtain an amorphous polyester resin A-2. The obtained amorphous polyester resin A-2 had a glass transition temperature (Tg) of −40° C. and a weight-average molecular weight (Mw) of 16,500.

### Synthesis of Amorphous Polyester Resin B-1

Plant-derived propylene glycol, terephthalic acid and plant-derived succinic acid were charged into in a four-neck flask equipped with a nitrogen introduction tube, a dehydration tube, an agitator, and a heat transfer pair, so that the molar ratio of terephthalic acid to succinic acid (terephthalic acid/succinic acid) was to be 86/14 and the molar ratio of OH/COOH (hydroxyl group to carboxyl group) was to be 1.3, and the mixture was allowed to react with titanium tetraisopropoxide (500 ppm relative to the resin component) for 8 hours at 230° C. under normal pressure, followed by a reaction at a reduced pressure of 10 to 15 mmHg for 4 hours, then trimellitic anhydride was added to the reaction vessel so that the ratio was to be 1 mol % relative to the total resin component, and the reaction was carried out at 180° C. under normal pressure for 4 hours to obtain an amorphous polyester resin B-1. The obtained amorphous polyester resin B-1 had a glass transition temperature (Tg) of 57° C. and a weight-average molecular weight (Mw) of 10,000.

### Synthesis of Amorphous Polyester Resin B-2

Plant-derived propylene glycol, 2 mol adduct of bisphenol A propylene oxide, terephthalic acid, and plant-derived succinic acid were charged into a four-neck flask equipped with a nitrogen introduction tube, a dehydration tube, an agitator, and a thermocouple, so that the molar ratio of the propylene glycol to the 2 mol adduct of bisphenol A ethylene oxide was to be 65/35 (propylene glycol/2 mol adduct of bisphenol A ethylene oxide), the molar ratio of terephthalic acid to succinic acid was to be 86/14 (terephthalic acid/succinic acid), and the molar ratio of hydroxyl group to carboxyl group, OH/COOH, was to be 1.3. The mixture was allowed to react with titanium tetraisopropoxide (500 ppm relative to the resin component) at atmospheric pressure at 230° C. for 8 hours, followed by further reacting at a reduced pressure of 10 to 15 mmHg for 4 hours. Trimellitic anhydride was added to the reaction vessel so as to be 1 mol % of trimellitic anhydride relative to the total resin component, and the reaction was carried out at normal pressure at 180° C. for 4 hours to obtain an amorphous polyester resin B-2. The obtained amorphous polyester resin B-2 had a glass transition temperature (Tg) of 52° C. and a weight-average molecular weight (Mw) of 9,000.

### Synthesis of Amorphous Polyester Resin B-3

2 mol adduct of bisphenol A ethylene oxide, 2 mol adduct of bisphenol A propylene oxide, terephthalic acid, and adipic acid were charged into a four-neck flask equipped with a nitrogen introduction tube, a dehydration tube, an agitator, and a thermocouple, so that the molar ratio of the 2 mol adduct of bisphenol A propylene oxide to 2 mol adduct of bisphenol A ethylene oxide (2 mol adduct of bisphenol A propylene oxide/2 mol adduct of bisphenol A ethylene oxide) was to be 60/40, the molar ratio of terephthalic acid to adipic acid (terephthalic acid/adipic acid) was to be 97/3, and the molar ratio of hydroxyl group to carboxyl group, OH/COOH, was to be 1.3. The mixture was allowed to react with titanium tetraisopropoxide (500 ppm relative to the resin component) at atmospheric pressure at 230° C. for 8 hours, followed by further reacting at a reduced pressure of 10 to 15 mmHg for 4 hours. Trimellitic anhydride was added to the reaction vessel so as to be 1 mol % of trimellitic anhydride relative to the total resin component, and the reaction was carried out at normal pressure at 180° C. for 4 hours to obtain an amorphous polyester resin B-3. The obtained amorphous polyester resin B-3 had a glass transition temperature (Tg) of 65° C. and a weight-average molecular weight (Mw) of 9,000.

### P-1: Introduction of PET

Flaked recycled PET was mixed so as to be the percentages of solid content shown in Table 1 when mixing the materials in the synthesis of amorphous polyester resin above.

### Synthesis of Crystalline Polyester Resin C-1

Plant-derived sebacic acid and plant-derived ethylene glycol were charged into a 5L four-neck flask equipped with a nitrogen introduction tube, a dehydration tube, an agitator, and a thermocouple so that the molar ratio of hydroxide to carboxyl group, OH/COOH, was to be 0.9, and was allowed to react with titanium tetraisopropoxide (500 ppm relative to the resin component) at 180° C. for 10 hours. Then, the temperature was raised to 200° C. for 3 hours, and then the mixture was further reacted at a pressure of 8.3 kPa for 2 hours to obtain a crystalline polyester resin C-1. The obtained crystalline polyester resin C-1 had a melting point of 72° C. and a weight-average molecular weight (Mw) of 20,000.

### Synthesis of Crystalline Polyester Resin C-2

A crystalline polyester resin C-2 was obtained in the same manner as above synthesis of crystalline polyester resin C-1, except that the diol was changed to 1,6-hexanediol. The obtained crystalline polyester resin C-2 had a melting point of 67° C. and a weight-average molecular weight (Mw) of 25,000.

### Synthesis of Crystalline Polyester Resin C-3

A crystalline polyester resin C-3 was obtained in the same manner as above synthesis of crystalline polyester resin C-1, except that dicarboxylic acid was changed to petroleum-derived sebacic acid and diol was changed to 1,6-hexanediol. The obtained crystalline polyester resin C-3 had a melting point of 65° C. and a weight-average molecular weight (Mw) of 25,000.

### Preparation of Crystalline Polyester Resin Dispersion Liquid C-1

45 parts by mass of the crystalline polyester resin C-1 and 450 parts by mass of ethyl acetate were charged into a container set with a stirring rod and a thermometer, and the temperature of the mixture was raised to 80° C. under stirring, kept at 80° C. for 5 hours, and then cooled to 30° C. in 1 hour. The mixture was then dispersed by using a bead mill (Ultra Visco Mill, manufactured by IMEX Co., Ltd.) under the conditions of feeding speed of 1 kg/hr, disk circumferential speed of 6 m/s, filling 80 vol. % of 0.5 mm diameter zirconia beads, and three passes to obtain a crystalline polyester resin dispersion liquid C-1. The volume average particle size of the obtained crystalline polyester resin particles was 450 nm, and the concentration of solid content of the resin particles was 10%.

### Preparation of Crystalline Polyester Resin Dispersion Liquids C-2 and C-3

A crystalline polyester resin dispersion liquid C-2 and a crystalline polyester resin dispersion liquid C-3 were obtained in the same manner as in the preparation of the crystalline polyester resin dispersion liquid C-1, except that the crystalline polyester resin C-1 was changed to the crystalline polyester resin C-2 or the crystalline polyester resin C-3.

### Preparation of WAX Dispersion Liquid 1

180 parts by mass (WE-11, Synthetic wax of plant-derived monomers, melting point 67° C., manufactured by NOF Corporation) of ester wax and 17 parts by mass (Neogen SC, sodium dodecylbenzene sulfonate, manufactured by Daiichi Kogyo Co., Ltd.) of anionic surfactant were added to 720 parts by mass of ion-exchanged water. The mixture was subjected to dispersion treatment with a homogenizer while being heated to 90° C. to obtain a WAX dispersion liquid 1. The volume average particle size of wax particles contained in the obtained WAX dispersion liquid 1 was 300 nm, and the concentration of solid content of the resin particles was 25%.

### Preparation of Master Batch (MB) 1

1,200 parts by mass of water, 500 parts by mass of carbon black (Printex 35, manufactured by Degussa AG) [DBP oil absorption=42 mL/100 mg, pH=9.5], and 500 parts by mass of the amorphous polyester resin B-1 were added and mixed in a Henschel mixer (manufactured by NIPPON COKE & ENGINEERING. CO., LTD), the mixture was kneaded for 30 minutes at 150° C. using two rolls, then rolled and cooled, followed by pulverizing by a pulperizer to obtain a master batch 1.

### Preparation of Master Batch (MB) 2

A master batch 2 was obtained in the same manner as in the preparation of master batch (MB) 1, except that the amorphous polyester resin B-1 was changed to the amorphous polyester resin B-3.

### Production of Resin Particles

### Example 1

(Oil Phase Preparation Step)

50 parts by mass of the amorphous resin A-2, 50 parts by mass of the crystalline polyester resin dispersion liquid C-1, 50 parts by mass of the WAX dispersion liquid 1, 550 parts by mass of the amorphous polyester resin B-3, 200 parts by mass of P-1, and 100 parts by mass of the master batch 1 were put into a container and mixed for 60 minutes at 5,000 rpm with a TK homomixer (manufactured by PRIMIX Corporation) to obtain an Oil Phase 1. The above contents indicate the amount of solid content in each raw material.

(Aqueous Phase Preparation Step)

990 parts by mass of water, 20 parts by mass of sodium dodecyl sulfate, and 90 parts by mass of ethyl acetate were mixed and stirred to obtain a milky white liquid. This was designated as an aqueous phase 1.

(Preparation Step of Emulsified Slurry)

700 parts by mass of the oil phase 1 was added with 20 parts by mass of 28% ammonia solution by a TK homomixer while stirring at 8,000 rpm, and after mixing for 10 minutes, 1,200 parts by mass of the aqueous phase 1 was gradually dropped to obtain an emulsified slurry 1.

(Preparation Step of Desolvated Slurry)

The emulsified slurry 1 was put into a container with an agitator and a thermometer, and the mixture was desolvated at 30° C. for 180 minutes to obtain a desolvated slurry 1.

(Agglomeration Step)

30 parts by mass of a 5, calcium chloride solution as a salt on agglomeration was added dropwise to the desolvated slurry 1, and stirred for 5 minutes. The temperature of the mixture was raised to 60° C. When the particle size became 5.0 μm, 30 parts by mass of calcium chloride was added to the mixture to finish the agglomeration step to obtain an agglomerated slurry 1.

(Fusion Step)

The agglomerated slurry 1 was heated to 70° C. with stirring and cooled to the desired average circularity of 0.957 to obtain a dispersed slurry 1.

(Washing and Drying Steps)

After 100 parts of the dispersed slurry 1 were filtered under reduced pressure, the following steps (1) to (4) were performed three times to obtain a filtered cake 1.
(1): 100 parts of ion-exchanged water were added to the filtered cake, mixed with a TK homomixer (10 minutes at 12,000 rpm) and filtered.
(2): 100 parts of 10% sodium hydroxide aqueous solution was added to the filtered cake of the above (1), mixed with a TK homomixer (at 12,000 rpm for 30 minutes), and filtered under reduced pressure.
(3): 150 parts of 10% hydrochloric acid was added to the filtered cake of the above (2), mixed with a TK homomixer (at 12,000 rpm for 20 minutes) and filtered.
(4): 300 parts of ion-exchanged water were added to the filtered cake of the above (3), mixed with a TK homomixer (at 12,000 rpm for 10 minutes) and filtered.

The obtained filtered cake 1 was dried at 45° C. for 48 hours in a circulating air dryer and sieved with a 75 μm mesh opening to obtain a resin particle base 1.

(External Additive Treatment Step)

2.0 parts by mass of hydrophobic silica (HDK-2000, manufactured by Clariant Corporation) as an external additive was mixed with 100 parts by mass of the resin particle base 1 by a Henschel mixer, and the mixture was passed through a sieve with 500 mesh opening to obtain resin particles 1.

### Examples 2 to 10 and Comparative Examples 1 to 4

Resin particles 2 to 14 were produced in the same manner as in Example 1, except that the types and amounts of prepolymers, WAX, crystalline resin, amorphous resin, and PET added in the oil phase preparation step and agglomeration step were changed as described in Table 1, and the types and amounts of salts in the agglomeration step and the washing conditions in the washing and drying steps were changed as described in Table 2.

TABLE 1

| | | Components | | | | | | Additive amount (solid content) [parts by mass] | | | | | |
|---|---|---|---|---|---|---|---|---|---|---|---|---|---|
| | | First | | First | Crystalline | | | First | | First | Crystalline | | |
| | | amor- | | amor- | polyester | | | amor- | | amor- | polyester | | |
| | | phous | Mas- | phous | resin | | | phous | Mas- | phous | resin | | |
| | | polyester | ter | polyester | dispersion | | | polyester | ter | polyester | dispersion | | |
| | Type | resin B | batch | resin A | liquid C | Wax | PET | resin B | batch | resin A | liquid C | Wax | PET |
| Example 1 | Resin particles 1 | B-3 | MB-1 | A-2 | C-2 | W-1 | P-1 | 550 | 100 | 50 | 50 | 50 | 200 |
| Example 2 | Resin particles 2 | B-3 | MB-1 | A-2 | C-2 | W-1 | P-1 | 550 | 100 | 50 | 50 | 50 | 200 |
| Example 3 | Resin particles 3 | B-3 | MB-1 | A-2 | C-2 | W-1 | P-1 | 550 | 100 | 50 | 50 | 50 | 200 |
| Example 4 | Resin particles 4 | B-3 | MB-1 | A-2 | C-2 | W-1 | P-1 | 550 | 100 | 50 | 50 | 50 | 200 |
| Example 5 | Resin particles 5 | B-1 | MB-1 | A-1 | C-2 | W-1 | P-1 | 550 | 100 | 50 | 50 | 50 | 200 |
| Example 6 | Resin particles 6 | B-2 | MB-1 | A-1 | C-2 | W-1 | P-1 | 450 | 100 | 50 | 50 | 50 | 300 |
| Example 7 | Resin particles 7 | B-2 | MB-1 | A-1 | C-2 | W-1 | P-1 | 450 | 100 | 50 | 50 | 50 | 300 |
| Example 8 | Resin particles 8 | B-2 | MB-1 | A-1 | C-2 | W-1 | P-1 | 450 | 100 | 50 | 50 | 50 | 300 |
| Example 9 | Resin particles 9 | B-2 | MB | A-1 | C-2 | W-1 | P-1 | 450 | 100 | 50 | 50 | 50 | 300 |
| Example 10 | Resin particles 10 | B-1 | MB-1 | A-1 | C-1 | W-1 | P-1 | 450 | 100 | 50 | 50 | 50 | 300 |
| Comparative | Resin particles 11 | B-2 | MB-1 | A-1 | C-1 | W-1 | P-1 | 750 | 100 | 50 | 50 | 50 | 0 |
| Example 1 | | | | | | | | | | | | | |
| Comparative | Resin particles 12 | B-3 | MB-2 | A-2 | C-3 | W-1 | P-1 | 550 | 100 | 50 | 50 | 50 | 200 |
| Example 2 | | | | | | | | | | | | | |
| Comparative | Resin particles 13 | B-2 | MB-1 | A-1 | C-2 | W-1 | P-1 | 450 | 100 | 50 | 50 | 50 | 300 |
| Example 3 | | | | | | | | | | | | | |
| Comparative | Resin particles 14 | B-2 | MB-1 | A-1 | C-2 | W-1 | P-1 | 450 | 100 | 50 | 50 | 50 | 300 |
| Example 4 | | | | | | | | | | | | | |

TABLE 2

| | | | | Conditions in the washing | |
|---|---|---|---|---|---|
| | | Salts used in the | | and drying steps | |
| | | agglomeration step | | Number | |
| | | | Parts | of times | |
| | Type | Solution | by mass | repeated | Note |
| Example 1 | Resin particles 1 | CaCl₂ | 30 | 3 | |
| Example 2 | Resin particles 2 | Sr(OH)₂ | 30 | 3 | |
| Example 3 | Resin particles 3 | MgSO₄ | 30 | 3 | |
| Example 4 | Resin particles 4 | MgSO₄ | 40 | 3 | |
| Example 5 | Resin particles 5 | MgSO₄ | 40 | 3 | |
| Example 6 | Resin particles 6 | MgSO₄ | 40 | 3 | |
| Example 7 | Resin particles 7 | MgSO₄ | 40 | 3 | |
| Example 8 | Resin particles 8 | MgSO₄ | 40 | 2 | |
| Example 9 | Resin particles 9 | MgSO₄ | 50 | 3 | |
| Example 10 | Resin particles 10 | MgSO₄ | 40 | 3 | |
| Comparative | Resin particles 11 | MgSO₄ | 40 | 3 | |
| Example 1 | | | | | |
| Comparative | Resin particles 12 | MgSO₄ | 40 | 3 | |
| Example 2 | | | | | |
| Comparative | Resin particles 13 | 1%-Al₂(SO₄)₃ | 10 | 3 | |
| Example 3 | | | | | |
| Comparative | Resin particles 14 | MgSO₄ | 50 | 2 | Steps (2) and (3) |
| Example 4 | | | | | in the washing and |
| | | | | | drying steps were |
| | | | | | not performed |

<Evaluation of Characteristics>

The resin particles from each of the above Examples and Comparative Examples were used as toners, and the characteristics of the toners were evaluated for environmental responsiveness, low-temperature fixability, image quality, and chargeability characteristics. The results of these evaluations are indicated in Table 3.

[Environmental Responsiveness]

The environmental responsiveness was evaluated based on the following evaluation criteria by the ratio of environmental responsiveness resin in the toner.

### (Evaluation Criteria)

A: The ratio of environmental responsiveness resin (biomass resin+recycled resin) was 60% or more.
B: The ratio of environmental responsiveness resin (biomass resin+recycled resin) was in a range from 30% to less than 60%.
C: The ratio of environmental responsiveness resin (biomass resin+recycled resin) was less than 30%.

[Low Temperature Fixability]

The carrier used for imageo MP C 5503 (manufactured by Ricoh Co., Ltd.) and the resin particles obtained above were mixed so that the concentration of the resin particles was 5% by mass, and the developing agent was obtained. After the developer was charged into the unit of imageo MP C 5503 (manufactured by Ricoh Co., Ltd.), a solid image of a 2 cm×15 cm rectangle was formed on PPC paper type 6000 <70W> A4 long grain paper (manufactured by Ricoh Co., Ltd.) so that the amount of toner deposited was to be 0.40 mg/cm². At this time, the surface temperature of the fixing roller was changed, and it was observed whether cold offset occurred in which the developed image of the solid image was fixed at a place other than the desired place, and the low-temperature fixability was evaluated based on the following evaluation criteria.

### (Evaluation Criteria)

A: Lower than 110° C.
B: 110° C. to less than 125° C.
C: 125° C. or higher

[Image Quality]

Image quality was evaluated by observing the reproducibility of fine lines. The resin particles were placed in imageo MP C 5503 (manufactured by Ricoh Co., Ltd.) and subjected to printing tests of 6 font size and 10 font size letters. The reproducibility of printed letters was evaluated based on the following criteria.

### (Evaluation Criteria)

A: 6 font size letters are clearly printed.
B: A part of 6 font size letters are blurry.
C: A part of 10 font size letters are blurry.

[Chargeability Characteristics]

The carrier used for imageo MP C 5503 (manufactured by Ricoh Co., Ltd.) and the resin particles obtained above were mixed so that the concentration of the resin particles was to be 71 by mass, and the developer was obtained. The developer was set in imageo MP C 5503 (manufactured by Ricoh Co., Ltd.) and running evaluation of 300,000 sheets was performed on an image chart of 50% image area in monochromatic mode. Then, the chargeability characteristics of the carrier after the running was evaluated by judging the changed amount in the chargeability amount based on the following criteria. The amount of change in the chargeability amount was defined by |Q1-Q2|, and was determined by the following. For the sample that has been shaked by YS-LD (shaker, manufactured by Yayoi) at scale 150 for 5 minutes and shaken about 1,100 times after being sealed by adding 6.000 g of initial carrier and 0.452 g of toner to a stainless-steel container after humidifying for at least 30 minutes in an environment (M/M environment) with a temperature of 23° C. and a relative humidity of 50%, the charged amount measured by the general blow-off method (TB-200, manufactured by Toshiba Chemical) was Q1, and for a carrier obtained by removing toner in the developer after the running by the blow-off device, the charged amount measured by the same method was Q2.

### (Evaluation Criteria)

A: The amount of change in the charging amount is less than 10 μc/g.
B: The amount of change in the charging amount is 10 μc/g or more and less than 20 μc/g.
C: The amount of change in the charging amount is 20 μc/g or more.

[Overall Evaluation]

The overall evaluation was determined based on the following criteria. Those having three or more “A” among all evaluation items and having “B” for the rest were determined as “A”, those having two “A” among the evaluation items and having “B” for the rest were determined as “B”, those having one “A” among the evaluation items and having “B” for the rest were determined as “C”, and those having one or more “C” among the evaluation items were determined as “D”.

### (Evaluation Criteria)

A: Excellent
B: Good
C: Slightly better than conventional
D: Not practical

TABLE 3

| | | | | | | | | | Evaluation | | | | |
|---|---|---|---|---|---|---|---|---|---|---|---|---|---|
| | | Concentration | Bio- | | Divalent metal | | | | Environ- | | | | |
| | | of radioactive | mass | | elements | | | Dv/ | mental | Low- | | | Overall |
| | | carbon isotope | resin | PET | | Amount | Na | Dn | respon- | temperature | Image | Charge- | evalu- |
| | Type | ¹⁴C [pMC] | [%] | [%] | Type | [%] | [%] | (—) | siveness | fixability | quality | ability | ation |
| Example 1 | Resin particles 1 | 11 | 10 | 20 | Ca | 0.07 | 0.08 | 1.25 | B | A | B | B | C |
| Example 2 | Resin particles 2 | 11 | 10 | 20 | Sr | 0.07 | 0.09 | 1.26 | B | A | B | B | C |
| Example 3 | Resin particles 3 | 11 | 10 | 20 | Mg | 0.07 | 0.07 | 1.21 | B | A | B | A | B |
| Example 4 | Resin particles 4 | 11 | 10 | 20 | Mg | 0.12 | 0.10 | 1.15 | B | B | A | A | B |
| Example 5 | Resin particles 5 | 35 | 33 | 20 | Mg | 0.13 | 0.13 | 1.27 | A | B | B | A | B |
| Example 6 | Resin particles 6 | 24 | 22 | 30 | Mg | 0.13 | 0.12 | 1.17 | A | A | A | B | A |
| Example 7 | Resin particles 7 | 24 | 22 | 30 | Mg | 0.13 | 0.10 | 1.09 | A | A | A | A | A |
| Example 8 | Resin particles 8 | 24 | 22 | 30 | Mg | 0.48 | 0.19 | 1.13 | A | A | A | A | A |
| Example 9 | Resin particles 9 | 24 | 22 | 30 | Mg | 0.62 | 0.13 | 1.21 | A | A | A | B | A |
| Example 10 | Resin particles 10 | 33 | 31 | 30 | Mg | 0.21 | 0.20 | 1.24 | A | A | A | A | A |
| Comparative | Resin particles 11 | 34 | 32 | 0 | Mg | 0.14 | 0.10 | 1.31 | B | A | C | C | D |
| Example 1 | | | | | | | | | | | | | |
| Comparative | Resin particles 12 | 5 | 5 | 20 | Mg | 0.13 | 0.13 | 1.19 | C | C | B | A | D |
| Example 2 | | | | | | | | | | | | | |
| Comparative | Resin particles 13 | 24 | 22 | 30 | — | 0 | 0.15 | 1.35 | A | B | C | C | D |
| Example 3 | | | | | | | | | | | | | |
| Comparative | Resin particles 14 | 24 | 22 | 30 | Mg | 1.2 | 0.13 | 1.23 | A | A | A | C | D |
| Example 4 | | | | | | | | | | | | | |

From Table 3, it was confirmed that the resin particles in Examples 1 to 10 were toner that satisfied the conditions for use in terms of environmental responsiveness, low-temperature fixability, image quality, and chargeability characteristics. On the other hand, the resin particles obtained in Comparative Examples 1 to 4 did not meet the conditions for use in terms of at least one of environmental responsiveness, low-temperature fixability, image quality, and chargeability characteristics, and it was confirmed that toner in Comparative Examples were not in practical use.

Therefore, unlike the resin particles of Comparative Examples 1 to 4, the resin particles of Examples 1 to 10 can provide high-quality toner with excellent environmental responsiveness, low-temperature fixability, image quality, and chargeability characteristics by containing PET or PBT, wherein the concentration of radioactive carbon isotope ¹⁴C in the resin particles is 10.8 pMC or more, and the content of divalent metal elements excluding external additives in the resin particles is in a range from 0.05% by mass to 1% by mass.

As described above, the above embodiment is presented as an example, and the present invention is not limited by the above embodiment. The above embodiment can be carried out in various other forms, and various combinations, omissions, replacements, modifications, and the like can be made without departing from the gist of the invention. These embodiments and their variations are included in the scope and abstract of the invention as well as in the equal scope of the invention described in the claims.

Embodiments of the present invention are, for example, as follows.

<1> Resin particles include polyethylene terephthalate or polybutylene terephthalate, wherein a concentration of radioactive carbon isotope ¹⁴C in the resin particles is 10.8 pMC or more, and wherein the resin particles contain 0.05% by mass or more and 1, by mass or less of a divalent metal element excluding an external additive.

<2> The resin particles according to <1>, include at least one of an amorphous resin and a crystalline resin, and at least one of the amorphous resin and the crystalline resin contains a biomass-derived resin, wherein a total content of the biomass-derived resin and the polyethylene terephthalate or the polybutylene terephthalate with respect to a total mass of the resin particles is 50% by mass or more.

<3> The resin particles according to <2>, wherein the polyethylene terephthalate or the polybutylene terephthalate are contained more than the biomass-derived resin in the resin particles.

<4> The resin particles according to any one of <1> to <3>, wherein a content of magnesium in the divalent metal element is 0.1% by mass or more and 0.5% by mass or less.

<5> The resin particles according to any one of <1> to <4>, wherein the resin particles contain sodium, wherein magnesium in the divalent metal elements is contained more than the sodium, and wherein a content of the sodium in the divalent metal elements exceeds 0.05% by mass.

<6> A toner composed of the resin particles of any one of <1> to <5>.

<7> A developer containing the toner of <6> and a carrier.

<8> A toner housing unit containing the toner of <6>.

<9> An image forming apparatus includes an electrostatic latent image bearer, an electrostatic latent image forming part that forms an electrostatic latent image on the electrostatic latent image bearer, a developing part that develops the electrostatic latent image using a toner to form a visible image, a transferring part that transfers the visible image onto a recording medium, and a fixing part that fixes a transferred image onto the recording medium, wherein the toner is the toner of <6>.

<10> A method of forming images includes an electrostatic latent image forming step that forms an electrostatic latent image on an electrostatic latent image bearer, a developing step that develops an electrostatic latent image using a toner to form a visible image, a transferring step that transfers the visible image onto a recording medium, and a fixing step that fixes a transferred image onto the recording medium, wherein the toner is the toner of <6>.

What is claimed is:

1. Resin particles comprising:
polyethylene terephthalate or polybutylene terephthalate,
wherein a concentration of radioactive carbon isotope ¹⁴C in the resin particles is 10.8 pMC or more, and
wherein the resin particles contain 0.05% by mass or more and 1% by mass or less of a divalent metal element excluding an external additive.

2. The resin particles according to claim 1, comprising:
at least one of an amorphous resin and a crystalline resin, and
at least one of the amorphous resin and the crystalline resin contains a biomass-derived resin,
wherein a total content of the biomass-derived resin and the polyethylene terephthalate or the polybutylene terephthalate with respect to a total mass of the resin particles is 50% by mass or more.

3. The resin particles according to claim 2, wherein the polyethylene terephthalate or the polybutylene terephthalate are contained more than the biomass-derived resin in the resin particles.

4. The resin particles according to claim 1, wherein a content of magnesium in the divalent metal element is 0.1% by mass or more and 0.5% by mass or less.

5. The resin particles according to claim 1,
wherein the resin particles contain sodium,
wherein magnesium in the divalent metal elements is contained more than the sodium, and
wherein a content of the sodium exceeds 0.05% by mass.

6. A toner composed of the resin particles of claim 1.

7. A developer containing the toner of claim 6 and a carrier.

8. A toner housing unit containing the toner of claim 6.

9. An image forming apparatus comprising:
an electrostatic latent image bearer;
an electrostatic latent image forming part that forms an electrostatic latent image on the electrostatic latent image bearer;
a developing part that develops the electrostatic latent image using a toner to form a visible image;
a transferring part that transfers the visible image onto a recording medium; and
a fixing part that fixes a transferred image onto the recording medium,
wherein the toner is the toner of claim 6.

10. A method of forming images comprising:
an electrostatic latent image forming step that forms an electrostatic latent image on an electrostatic latent image bearer;
a developing step that develops an electrostatic latent image using a toner to form a visible image;
a transferring step that transfers the visible image onto a recording medium; and
a fixing step that fixes a transferred image onto the recording medium,
wherein the toner is the toner of claim 6.
